(19) United States
(12) Patent Application Publication
(10) Pub. No.: US 2017/0278341 A1
(43) Pub. Date: Sep. 28, 2017

(54) SYSTEMS AND METHODS FOR MODIFYING A GRAPHICAL USER INTERFACE FOR AN ELECTRONIC GAME OF BACCARAT IN ORDER TO FACILITATE A MULTIPLIER FEATURE

(71) Applicant: Walker Digital Table Systems, LLC, Las Vegas, NV (US)

(72) Inventors: Stephen Moore, Las Vegas, NV (US); Michael Russell, Las Vegas, NV (US); John Daley, Las Vegas, NV (US)

(21) Appl. No.: 15/509,192

(22) PCT Filed: Oct. 24, 2015
(86) PCT No.: PCT/US15/57264

§ 371 Date: Mar. 6, 2017

Related U.S. Application Data
(60) Provisional application No. 62/068,684, filed on Oct. 25, 2014.

(51) Int. Cl. G07F 17/32; G06F 3/048

(52) U.S. Cl. CPC G07F 17/3213; G07F 17/3258; G06F 3/048; A63F 2001/001

(57) ABSTRACT

In accordance with some embodiments, an electronic baccarat game includes one or more multiplier feature improvements. One example of a multiplier improvement includes activating a bonus awarding mechanism (e.g., a wheel) once a plurality of qualifying conditions are satisfied during play of the primary game. In one example embodiments, the qualifying conditions include the obtainment of a Player Pair, a Banker Pair and a Tie during play of the primary game. In one embodiments, each of the qualifying conditions may be satisfied more than once and a multiplier associated with the bonus awarding mechanism (e.g., a multiplier corresponding to a respective qualifying condition) is increased each time the qualifying condition is satisfied.

### CLAIM OF PRIORITY

The present application claims the benefit of priority of U.S. Provisional Application No. 62/068,684 filed Oct. 25, 2014 in the name of Moore et al., titled SYSTEMS AND METHODS FOR BACCARAT. The entirety of each of this provisional application is incorporated by reference herein for all purposes.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BRIEF DESCRIPTION OF THE FIGURES

FIG. 1 is a schematic diagram of an embodiment of a gaming system in accordance with one or more embodiments described herein.

FIG. 2A is a block diagram of an embodiment of a gaming apparatus useful in at least some embodiments described herein.

FIG. 2B is a schematic diagram of an embodiment of a gaming apparatus useful in at least some embodiments described herein.

FIGS. 3A-3C comprise illustrations of an example Graphical User Interface for an electronic baccarat game utilizing a multiplier feature consistent with one or more embodiments described herein, as it may progress over a course of an example gaming session.

FIG. 4 is a flowchart illustrating a process according to one or more embodiments described herein.

FIG. 5 is a flowchart illustrating a process according to one or more embodiments described herein.

### DETAILED DESCRIPTION OF EXAMPLE EMBODIMENTS

### I. Introduction

Described herein are various embodiments of an inventive electronic (e.g., online) baccarat game which provides for at least one new kind of winning opportunity, and systems for managing a graphical user interface (GUI) to facilitate a player's interactions with an application for facilitating the electronic baccarat game. In accordance with some embodiments, an occurrence of one or more qualifying results during play of a primary game of baccarat comprises a pre-condition for activating a bonus feature and/or multiplier feature. In accordance with some embodiments, such play of the primary baccarat game may comprise multiple wagers placed on the primary baccarat game over a course of a session, such that a player may attempt to qualify for the bonus and/or multiplier feature over a course of a plurality of game events (e.g., by continuing to place wagers on game events in the primary game and, over time, achieving the one or more qualifying results in order to qualify for the bonus and/or multiplier feature).

In accordance with some embodiments, a baccarat game provides a novel mechanism for applying, qualifying for and/or triggering at least one multiplier feature. In accordance with some embodiments, such a multiplier feature may be applied to a bonus payout or prize while in other embodiments the multiplier feature may be applied to a payout of a primary game.

In accordance with some embodiments, at least one predetermined qualifying game outcome, once it occurs in a primary game of baccarat (e.g., a qualifying outcome in one or more hands of baccarat, such as a Player Pair), may cause a player to qualify for a bonus payout and/or a multiplier feature of the baccarat game to be activated. For example, in one embodiment, if a player obtains each of (i) a Player Pair; (ii) a Banker Pair; and (iii) a Tie in a session of a baccarat game, a bonus wheel is activated and the player is provided with an opportunity to win a bonus prize. In one embodiment, a player may qualify for a multiplier to be applied to prizes won as a result of the bonus feature. In one embodiment, the value of the multiplier may be based on outcomes achieved in the primary game of baccarat prior to the bonus feature being activated. For example, in one embodiment a value of the multiplier may be increased for each occurrence of a qualifying outcome in the primary game of baccarat (e.g., the second time within a session prior to a bonus feature being activated that the player obtains a Player Pair, a multiplier associated with the bonus feature is increased from 1X to 2X).

In accordance with some embodiments, a multiplier obtained (or modified) as a result of a first hand of baccarat may be applied to a payout resulting from a second and subsequent hand of baccarat (e.g., within a primary game of baccarat). In accordance with some embodiments, a multiplier value may escalate over a course of a plurality of hands (e.g., subsequent hands) of baccarat if certain qualifying conditions are satisfied, the multiplier being applied to one or more hands in the primary game of baccarat or to a bonus payout in a bonus feature of the game.

In one embodiment, a primary game of baccarat comprises an opportunity to place a wager on one or more hands of baccarat. A hand of baccarat, in accordance with some embodiments, consists of a set of element positions (e.g., six element positions per hand), with a first subset of element positions of each hand attributable to the Banker side and a second subset of element positions of each hand attributable to the Player side (e.g., three element positions attributable to the Banker side and three element positions attributable to the Banker side). In accordance with some embodiments, a player selects a side when making a wager: Banker or Player. For each hand corresponding to a given wager, six cards are determined, with three of the six cards being attributable to the Player side and three being attributable to the Banker side, the six cards being placed within the element positions along each payline. In some embodiments or circumstances, less than three cards for at least one of the Banker side and the Player side may be determined and/or placed, as explained elsewhere herein. At the resolution of a given game event (when all element positions of each hand corresponding to the wager have been populated with cards or at least when all elements and positions thereof have been determined, even if they have not yet been placed or revealed to the player), it is determined whether the Banker side wins, the Player side wins or whether the result is a Tie. In accordance with some embodiments, multiple (e.g., three) hands of baccarat may be dealt for a single wager placed by the player. For example, in an embodiment in which a player places a single wager of $X in exchange for three hands being dealt, a portion of the wager may be attributed on the backend by the system to each of the three hands (e.g., ⅓ of $X is attributed to each of the three hands).

In accordance with some embodiments, in addition to evaluating the result of each hand to determine whether the player wins anything as a result of the wager (e.g., if the player wagered on the Banker side when placing the wager, the outcome of each hand is evaluated to determine whether the Banker side for that hand is the winner), the outcome of each hand may also be evaluated to determine whether it includes at least one qualifying event or satisfies at least one condition which contributes towards the player qualifying for a bonus payout and multiplier feature.

In accordance with some embodiments, in addition to evaluating the result of each hand to determine whether the player wins anything as a result of the wager, the outcome of each hand may also be evaluated to determine whether the player has earned a multiplier or an adjustment to a multiplier (e.g., an increase in a value of a previously obtained multiplier) as a result of the hand. For example, in some embodiments if a result of a hand qualifies for a multiplier, the multiplier may be applied to a win or payout won by the player as a result of a subsequent hand (i.e., the multiplier is not applied to a result of a hand corresponding to the wager which resulted in the multiplier being obtained by the player).

In accordance with some embodiments, a game mechanic comprises applying an escalating multiplier to consecutive hands of baccarat. For example, in one embodiment a value of a multiplier may continue to increase over a course of a plurality of wagers so long as the player wins the wagers or the wagers otherwise satisfy a condition which causes the value of the multiplier to be increased.

In accordance with some embodiments, a value of a multiplier may be determined based on a predetermined scheme (e.g., the multiplier, once qualified for, is set to an initial value of 2× and is increased to 3×, 4×, 5× and so forth if certain conditions for increasing the value of the multiplier continue to be satisfied). In other embodiments, a value of a multiplier (or a magnitude of an adjustment to a value of a multiplier) may be randomly determined. In yet other embodiments, a value of a multiplier (or a magnitude of an adjustment to a value of a multiplier) may be determined based on a characteristic of a hand (or side of a hand) of baccarat (e.g., based on a sum value for the hand, based on one or more cards included in a hand, based on whether the hand includes a predetermined combination of cards or a predetermined outcome, etc.).

Other improvements to a game of baccarat described herein comprise (i) allowing vertical paylines in a game of baccarat (in addition to traditional horizontal paylines); and (ii) removing, from a deck of cards used in a baccarat game, all cards of a certain value (e.g., all “4” cards).

In accordance with one embodiment, a first game interface for a primary aspect of a game of baccarat comprises a game symbol matrix (also referred to as a symbol matrix herein) which includes a plurality of positions, each position for displaying a respective game element or symbol of the game (e.g., a card of the baccarat game). The terms “element” and “symbol” are used interchangeably herein to refer to an image, character or other indicium of the game, used to indicate a result of the game. In accordance with one embodiment, the symbol matrix may be arranged such that there are three (3) hands or rows, each hand comprising six (6) element positions. In one embodiment, at the initiation of a new game event (e.g., dealing of a new set of hands of the baccarat game, by populating each of the symbol positions of the matrix with cards), three (3) hands of cards are dealt, each row having six (6) cards. Of course, the number of hands and the number of cards in each hand may be modified and the embodiments described herein are not dependent on any particular number of hands or cards in a hand.

In some hands, not all available card positions (e.g., not all six (6) card positions) of a given hand may be needed to determine a winning side for the hand. For example, in accordance with some rules for a baccarat game, initially only two (2) cards are dealt to the player side and two (2) cards are dealt to the Banker side and a third card may not be dealt or needed in order to determine whether the Banker side or the Player side wins the hand (e.g., it may be, based on the initial four (4) cards dealt, that the player side is dealt a natural 8 or 9 and is the winning side). Or, similarly, although three (3) cards may be dealt face-down for each side, only two (2) cards of each side may be flipped over or otherwise revealed to determine a point value for each side and the third card may initially remain face-down. For example, even if three (3) cards are dealt to each of the player side and the banker side, in some circumstances only two (e.g., the first two) cards may be utilized to determine a respective value for each side and therefore a winning side for the hand. In embodiments in which the fifth or sixth card is not needed or desired to be dealt to complete a hand (or such card(s) is/are dealt but is/are not utilized to determine a winning side for the hand, and perhaps not initially revealed to the player), such a position may be utilized to effectuate a bonus or secondary feature for the game. For example, in accordance with one embodiment, any four or five card hands will be given an extra card with a value of 0 (10, J, Q, or K) to complete the six card hand.

In accordance with some embodiments, a determination of whether, in a hand or set of cards (e.g., six cards) in a game of baccarat consistent with the embodiments described herein, the Banker side wins or the Player side wins (or whether there is a Tie) may be based on a valuation of the cards in accordance with the traditional rules of valuating a hand in baccarat. For example, each card dealt to the Banker side (i.e., the Banker hand) and each card dealt to the Player side (i.e., the Player hand) may be attributed a point value as follows: (i) cards having the numerals two (2) through nine (9) depicted thereon may have their face value in points (e.g., a card with a “2” on it is worth 2 points towards a final point value of the hand, a card with a “3” on it is worth 3 points towards a final point value of the hand, etc.); (ii) cards having 10s, Js, Qs and Ks may have a zero point value (i.e. are worth zero points); and (iii) Aces may have a 1 point value (Jokers may, in some embodiments, not be used in the game). Further, each of the Banker hand and the Player hand may be valued by summing the point value of each card comprising the respective hand according to the rightmost digit of the sum of their constituent cards: for example, a hand consisting of 2 and 3 is worth 5, but a hand consisting of 6 and 7 is worth 3 (i.e. the 3 being the rightmost digit in the combined points total: 13), such that the highest possible hand value in Baccarat is 9. The hand with the highest point value (or the point value closest to 9) may be considered the winning hand (e.g., if Banker hand has a value of 7 and Player hand has a value of 9, the Player side is determined to be the winning hand or winning side). Of course, any desired scheme for valuing hands, point system for attributing value to cards comprising a hand of other mechanism for determining a winning side or a winning hand may be implemented. The above methodology is provided as an example only and the embodiments described herein are not dependent on any particular method for determining whether the Player side or the Banker side wins a given hand or game event in a game of baccarat.

It should be noted that, in accordance with some embodiments, the payouts for Banker side wins and Player side wins may be determined in accordance with odds consistent with the odds used in traditional games of baccarat. For example, a payout for a Banker side win may be paid 1:0.95 while a payout for a Player side win may be paid 1:1 in a commission structure in which the house takes a commission. Or, in a no commission structure, the payout odds for a Banker side wins may be adjusted such that a Banker side win may be paid 1:1, except on a Banker side win of 6, in which case the payout odds would be 1:0.50. The Banker side win odds are adjusted in a no commission structure such that the odds of the game are not impacted. Thus, for example, a $100 Banker wager that wins gets paid back the original $100 and an additional $100 or $100 profit on any Banker win of 1, 2, 3, 4, 5, 7, 8, 9 while a Banker wager of $100 with a win of $100 pays back the original $100 and an additional $50 or $50 profit on a banker win of 6. Player payouts do not change. It should be understood that any payout odds may be used in a baccarat game consistent with embodiments described herein; the above odds scheme are provided for illustrative purposes only and are not to be taken in a limiting fashion.

The determination of which card to deal into each row or hand of cards may be based on one or more sources. For example, in one embodiment a random number generator (comprising software and/or hardware for selecting cards to be dealt for a hand or other game event on a random or pseudo-random basis) may be utilized to determine the cards to be dealt as an outcome of a hand, bet or other game event for a video baccarat game as described herein. In another embodiment, “live game play data” may be a source for determining the cards. Live game play data may comprise data indicating cards dealt (simultaneously or essentially simultaneously, such as within the past predetermined period of time, such as within the past thirty (30) minutes or less) on one or more physical tables (e.g., cards dealt from a physical shoe at the table or manually dealt by a dealer). The live game play data may include, for example, an indication of at least one of (i) an outcome determined for a respective one or more hands, bets or other game events; (ii) a result determined for a respective one or more hands, bets or other game events (e.g., a payout won, an indication of a winner for a hand, bet or other game event), (iii) a rank or characteristic of a hand, bet or other game event; (iv) a suit, rank or other characteristic of a card or other game indicia output for a respective one or more hands, bets or other game events; (v) the one or more cards or other game indicia output for a respective one or more hands, bet or other game events. It should be noted that there may be some overlap in the scope of the examples listed above (e.g., an indication of an outcome in a card game may comprise an indication of a card comprising the outcome).

Live table games generally include a live dealer that deals randomly-ordered physical playing cards to players seated at a physical gaming table, and involves the use of physical gaming chips for wagering by the players at the gaming table during the play of the game. A live table game may also involve an automated system for dealing physical playing cards to players seated at a physical gaming table but without a live dealer present (e.g., the physical table may provide for a remote dealer or software which simulates a dealer).

In accordance with some embodiments, live game play data may be obtained through wager detections systems, which may include at least one of hardware and software for identifying, storing, analyzing and/or transmitting events (e.g., results, outcomes, wagers, etc.) which have occurred during or in association with a live table game. For example, a wager detection system may include at least one of (i) RFID tagged gaming chips and corresponding RFID sensing devices; (ii) one or more card reading devices; (iii) a camera positioned to capture card images for detection; (iv) an optical reader incorporated in a gaming table; (v) an automated shuffling device and a playing card shoe (e.g., an electronic shoe which is operable to communicate with a processor to indicate at least one of an outcome or result of a wager and/or the game symbols comprising an outcome for a wager); (vi) Near Field Communication (NFC) protocols; and (vii) proximity card technology. Once received or otherwise determined, the live game play data may be stored, processed, analyzed, selected and/or communicated as repurposed game play data for display on one or more player devices through any appropriate wired or wireless communication hardware and software technology.

In one embodiment, a source of live game play data may comprise a table selected by a player. For example, in one embodiment a player may be requested, upon initiating a new game, to indicate whether (s)he is wagering on a Player side or a Banker side. The system may then determine, based on live game play data, a plurality of live tables with active trends on the selected side, whether Player or Banker. The live game play data may be for tables within a single gaming establishment or for tables across multiple gaming establishments. A representation or indication of the identified tables may then be presented to the player (or a subset of the identified tables, if there is a large number of tables identified as having trends on the selected side). The player may then be provided with an opportunity to select a specified number of the tables with active trends (e.g., one, two or three tables, depending on the number of hands being played in the base game) and the cards dealt in the next hands (or the outcomes of the next hands dealt) on the selected tables will comprise the cards dealt in the initial game being played by the player.

The systems, processes and articles of manufacture described herein may be operable to utilize the live game play data as repurposed game play data to provide games or wagering opportunities at one or more of player devices. The wagering opportunities or games so provided may be based on, or simulations of, the live game play data of the underlying game or original game from which the data originated. In one embodiment, the systems, methods and articles of manufacture described herein may be operable to provide additional wagering games or opportunities which differ from the underlying or original game based upon which the game data was determined.

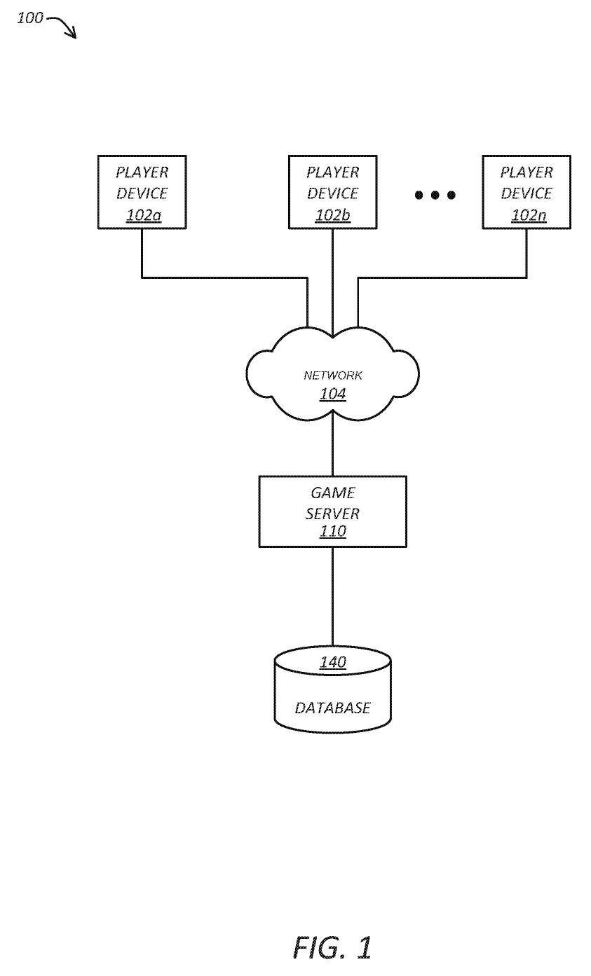

In yet another example, a source for cards to be dealt in a virtual baccarat game may comprise “historical game play data”. Historical game play data may comprise, for example, data indicating cards dealt (or any of the other data types described with respect to live game play data) which was determined at a physical table (or electronic baccarat device) more than a predetermined period of time ago (e.g., more than thirty (30) minutes ago), which has been stored in a database or other memory mechanism. A system controller, which may take any form, including one or more general purpose computers, specific purpose computers or servers, may receive, determine, store, analyze, categorize, select and/or repurpose the live game play data for one or more additional wagering opportunities on a player device (e.g., a dedicated device for outputting a virtual baccarat game or a non-dedicated device such as a smart phone or tablet computer, on which software for facilitating the baccarat game has been installed). Various examples of player devices are described herein with respect to FIG. 1.

In accordance with some embodiments, systems, methods and articles of manufacture (e.g., non-transitory computer-readable medium) provide for (i) outputting, on a display device, a first electronic game interface comprising an area for displaying at least one hand of baccarat, each at least one hand of baccarat comprising a plurality of element positions for placement of game elements and including a first subset of the plurality of element positions corresponding to a Player side and a second subset of the plurality of element positions corresponding to a Banker side; (ii) outputting, on the display device, a second electronic game interface comprising a bonus awarding mechanism having displayed thereon a plurality of available bonus prizes and an indicator of a plurality of activation conditions which must be obtained during play of the primary game in order for the bonus awarding mechanism to be activated; (iii) determining, for each plurality of element positions comprising a hand, an outcome of the hand; (iv) placing, for a game instance of the primary game on which a player has placed a wager and based on the determined outcomes, game elements into the plurality of element positions for each hand; (v) determining which one of Player side and Banker side the player has selected when placing the wager, thereby determining the player's win prediction for the game instance; (vi) determining a primary payout for the game instance of the primary game based on an amount of the wager, the player's win prediction and the outcome for each hand; (vii) determining that at least one outcome satisfies at least one activation condition for the bonus feature; (viii) modifying the second electronic game interface to indicate that at least one activation condition has been satisfied; (ix) determining that each of the plurality of activation conditions for the bonus awarding mechanism has been satisfied over a course of at least one game instance of the primary game, thereby activating the bonus awarding mechanism; and (x) awarding a bonus prize based on a resolution of the bonus awarding mechanism.

In accordance with some embodiments, systems, methods and articles of manufacture (e.g., non-transitory computer-readable medium) provide for (i) outputting, on a display device, an electronic game interface comprising (a) an area for displaying at least one hand of baccarat, the area comprising, for each at least one hand, a plurality of element positions for placement of game elements and including a first subset of the plurality of element positions corresponding to a Player side and a second subset of the plurality of element positions corresponding to a Banker side; and (b) an indicator of at least one multiplier to be applied to a prize awarded in the electronic baccarat game; (ii) determining an outcome of the first hand, including the game elements to place for a first hand; (iii) placing, for a game instance of the primary game on which a player has placed a wager, a first set of game elements into a first plurality of element positions to represent the first outcome of the first hand for the game instance; (iv) determining which one of Player side and Banker side the player has selected when placing the wager, thereby determining the player's win prediction for the game instance; (v) determining a value of the multiplier based on a characteristic of the first hand; (vi) modifying the electronic game interface to indicate the determined value; and (vii) determining a payout for the game instance of the primary game based at least on the player's win prediction, the outcome and the value of the multiplier.

In accordance with some embodiments, systems, methods and articles of manufacture (e.g., non-transitory computer-readable medium) provide for (i) outputting, on a display device, an electronic game interface comprising (a) an area for displaying at least one hand of baccarat, each at least one hand of baccarat comprising a plurality of element positions for placement of game elements and including a first subset of the plurality of element positions corresponding to a Player side and a second subset of the plurality of element positions corresponding to a Banker side; and (b) an indicator of at least one multiplier to be applied to a prize awarded in the electronic baccarat game; (ii) placing, for a first game instance of the primary game on which a player has placed a first wager, a first set of game elements into a first plurality of element positions, thereby determining a first hand for the first game instance; (iii) determining which one of Player side and Banker side the player has selected when placing the first wager, thereby determining the player's first win prediction for the first game instance; (iv) determining a first outcome of the first hand; (v) determining a value of the multiplier based on a characteristic of the first hand, thereby determining a first multiplier value; (vi) modifying the electronic game interface to indicate the first multiplier value; (vii) determining a first payout for the first game instance based at least on the player's first win prediction and the first outcome of the first hand; (viii) placing, for a second game instance of the primary game on which a player has placed a second wager subsequent to the determining of the first outcome, a second set of game elements into the first plurality of element positions, thereby determining a second hand for the second game instance; (ix) determining which one of Player side and Banker side the player has selected when placing the second wager, thereby determining the player's second win prediction for the second game instance; (x) determining a second outcome of the second hand; and (xi) determining a second payout for the second hand based on the second win prediction, the second outcome and the first multiplier value determined based on the characteristic of the first hand.

Certain aspects, advantages, and novel features of various embodiments of a baccarat game are described herein. For example, an electronic baccarat game in accordance with at least some embodiments described herein allows lower bankroll players to enjoy the game of baccarat more readily and allows for a baccarat game with more volatility, which may be attractive to some players who do not currently prefer the low volatility of conventional baccarat games. It is to be understood that not necessarily all such advantages may be achieved in accordance with any particular embodiment. Thus, for example, those skilled in the art will recognize different embodiments may be implemented or carried out in a manner that achieves one advantage or group of advantages as taught herein without necessarily achieving other advantages as may be taught or suggested herein.

Although several embodiments, examples and illustrations are disclosed below, it will be understood by those of ordinary skill in the art that the invention described herein extends beyond the specifically disclosed embodiments, examples and illustrations and includes other uses of the invention and obvious modifications and equivalents thereof. Embodiments of the invention(s) are described with reference to the accompanying figures, wherein like numerals refer to like elements throughout. The terminology used in the description presented herein is not intended to be interpreted in any limited or restrictive manner simply because it is being used in conjunction with a detailed description of certain specific embodiments of the invention(s). In addition, embodiments of the invention(s) can comprise several novel features and it is possible that no single feature is solely responsible for its desirable attributes or is essential to practicing the invention(s) herein described.

Throughout the description that follows and unless otherwise specified, the following terms may include and/or encompass the example meanings provided in this section. These terms and illustrative example meanings are provided to clarify the language selected to describe embodiments both in the specification and in the appended claims, and accordingly, are not intended to be limiting. Other terms are defined throughout the present description.

A “game”, as the term is used herein unless specified otherwise, may comprise any game (e.g., wagering or non-wagering, electronically playable over a network) playable by one or more players in accordance with specified rules. A game may be playable on a personal computer online in web browsers, on a game console or terminal and/or on a mobile device such as a smart-phone or tablet computer. A game may also be playable on a dedicated gaming device (e.g., a slot machine-type of device in a brick-and-mortar casino). “Gaming” thus refers to play of a game.

A “session” of a game, as the term is used herein, may comprise a plurality of consecutive game instances (e.g., a plurality of wagers placed by a player on consecutive game outcomes) over a period of time having a start time and an end time, with continuous or semi-continuous play of the game in between. For example, in a game playable on a dedicated gaming device comprising a player card reader and/or credit meter balance, a session may be considered to be the period of game play from a time a particular player inserts his player card and/or establishes a credit balance with the gaming device (or selects the game for play, in a gaming device which provides access to more than one game) to a time the player removes his player card and/or cashes out his credit balance (or selects an “end game” or equivalent option on the gaming device, if more than one game is available on the gaming device). In an example of an online game, a session may be considered to begin once a player logs onto a website for accessing the online game and selects the game for play to a time the player closes out of the game of selects an “end game” or equivalent option on the website.

A “wagering game”, as the term is used herein, may comprise a game on which a player can risk a wager or other consideration. A wager may comprise a monetary wager in the form of an amount of currency or any other tangible or intangible article having some value which may be risked on an outcome of a wagering game. “Gambling” or “wagering” refers to play of a wagering game.

The term “game provider”, as used herein unless specified otherwise, refers to an entity or system of components which provides, or facilitates the provision of, games for play. For example, a game provider may comprise a designer, manufacturer, supplier or retailer of the game.

The terms “information” and “data”, as used herein unless specified otherwise, may be used interchangeably and may refer to any data, text, voice, video, image, message, bit, packet, pulse, tone, waveform, and/or other type or configuration of signal and/or information. Information may comprise information packets transmitted, for example, in accordance with the Internet Protocol Version 6 (IPv6) standard as defined by “Internet Protocol Version 6 (IPv6) Specification” RFC 1883, published by the Internet Engineering Task Force (IETF), Network Working Group, S. Deering et al. (December 1995). Information may, according to some embodiments, be compressed, encoded, encrypted, and/or otherwise packaged or manipulated in accordance with any method that is or becomes known or practicable.

The term “indication”, as used herein unless specified otherwise, may refer to any indicia and/or other information indicative of or associated with a subject, item, entity, and/or other object and/or idea. As used herein, the phrases “information indicative of” and “indicia” may be used to refer to any information that represents, describes, and/or is otherwise associated with a related entity, subject, or object. Indicia of information may include, for example, a code, a reference, a link, a signal, an identifier, and/or any combination thereof and/or any other informative representation associated with the information. In some embodiments, indicia of information (or indicative of the information) may be or include the information itself and/or any portion or component of the information. In some embodiments, an indication may include a request, a solicitation, a broadcast, and/or any other form of information gathering and/or dissemination.

The term “network component,” as used herein unless specified otherwise, may refer to a user or network device, or a component, piece, portion, or combination of user or network devices. Examples of network components may include a Static Random Access Memory (SRAM) device or module, a network processor, and a network communication path, connection, port, or cable.

In addition, some embodiments are associated with a “network” or a “communication network”. As used herein, the terms “network” and “communication network” may be used interchangeably and may refer to any object, entity, component, device, and/or any combination thereof that permits, facilitates, and/or otherwise contributes to or is associated with the transmission of messages, packets, signals, and/or other forms of information between and/or within one or more network devices. Networks may be or include a plurality of interconnected network devices. In some embodiments, networks may be hard-wired, wireless, virtual, neural, and/or any other configuration of type that is or becomes known. Communication networks may include, for example, one or more networks configured to operate in accordance with the Fast Ethernet LAN transmission standard 802.3-2002® published by the Institute of Electrical and Electronics Engineers (IEEE). In some embodiments, a network may include one or more wired and/or wireless networks operated in accordance with any communication standard or protocol that is or becomes known or practicable.

The term “player,” as used herein unless specified otherwise, may refer to any type, quantity, and or manner of entity associated with the play of a game. In some embodiments, a player may comprise an entity (i) conducting play of an online game, (ii) that desires to play a game (e.g., an entity registered and/or scheduled to play and/or an entity having expressed interest in the play of the game—e.g., a spectator) and/or may (iii) that configures, manages, and/or conducts a game. A player may be currently playing a game or have previously played the game, or may not yet have initiated play—i.e., a “player” may comprise a “potential player” (e.g., in general and/or with respect to a specific game). In some embodiments, a player may comprise a user of an interface (e.g., whether or not such a player participates in a game or seeks to participate in the game).

Some embodiments described herein are associated with a “player device” or a “network device”. As used herein, a “player device” is a subset of a “network device”. The “network device”, for example, may generally refer to any device that can communicate via a network, while the “player device” may comprise a network device that is owned and/or operated by or otherwise associated with a player. Examples of player and/or network devices may include, but are not limited to: a Personal Computer (PC), a computer workstation, a computer server, a printer, a scanner, a facsimile machine, a copier, a Personal Digital Assistant (PDA), a storage device (e.g., a disk drive), a hub, a router, a switch, and a modem, a video game console, or a wireless or cellular telephone. Player and/or network devices may, in some embodiments, comprise one or more network components.

A “game event”, “event instance”, “game instance”, “hand” or “turn” is triggered upon an initiation of, or request for, at least one result of the game by a player, such as an actuation of a “start” or “deal” mechanism, which initiation causes an outcome to be determined or generated (e.g., a random number generator is contacted or communicated with to identify, generate or determine a random number to be used to determine a result for the event instance). An event instance or turn may comprise an event instance or turn of a primary game or an event instance or turn of a bonus round, mode or feature of the game. For example, actuation by a player of a “deal” mechanism may cause an appropriate number of cards to be dealt to the player for a new hand of a baccarat game. In some embodiments, a single event instance or turn of a game may comprise a dealing of a plurality of hands simultaneously (e.g., each hand being dealt based on the same random number and/or deck of cards, or each hand being dealt based on a different random number and/or deck of cards).

“Virtual currency” as the term is used herein unless indicated otherwise, refers to an in-game currency that may be used as part of a game or one or more games provided by a game provider as (i) currency for making wagers, and/or (ii) to purchase or access various in-game items, features or powers. References to an “award”, “prize” and/or “payout” herein are intended to encompass such in the form of virtual currency, credits, real currency or any other form of value, tangible or intangible.

A “credit balance”, as the term is used herein unless indicated otherwise, refers to (i) a balance of currency, whether virtual currency or real currency, usable for making wagers or purchases in the game (or relevant to the game), and/or (ii) another tracking mechanism for tracking a player's success or advancement in a game by deducting therefrom points or value for unsuccessful attempts at advancement and adding thereto points or value for successful attempts at advancement. A credit balance may be increased or replenished with funds external to the game. For example, a player may transfer funds to the credit balance from a financial account or a gaming establishment may add funds to the credit balance due to a promotion, award or gift to the player.

Referring now to the figures, FIG. 1 depicts a block diagram of an example system 100 according to some embodiments. The system 100 may comprise a plurality of player devices 102a-102n in communication with a game server 110 via a network 104. For purposes of brevity, any or all of the player devices 102a-102n will be referred to as a player device 102 herein, even though the plurality of player devices 102a-102n may include different types of player devices (as described below). The game server 110 may also be operable to communicate with or access a database 140 (which may comprise one or more databases and/or tables and which may comprise a storage device distinct from (or be a component of) the game server 110). It should be noted that in some embodiments database 140 may be stored on a game server 110 while in other embodiments database 140 may be stored on another computing device with which game server 110 is operable to communicate in order to at least access the data in database 140 (e.g., another server device remote from game server 140, operable to determine outcomes for an event instance of a game). In some embodiments a processor (e.g., one or more microprocessors, one or more microcontrollers, one or more digital signal processors) of a player device 102 and/or game server 110 may receive instructions (e.g., from a memory or like device), and execute those instructions, thereby performing one or more processes defined by those instructions. Instructions may be embodied in, e.g., one or more computer programs and/or one or more scripts.

In some embodiments a game server 110 and/or one or more of the player devices 102 stores and/or has access to data useful for facilitating play of a game. For example, game server 110 and/or a player device 102 may store (i) one or more probability databases for determining one or more outcome(s) for an event instance, hand or turn of a game, (ii) a current state or status of a game or game session (e.g., whether a result of at least one hand satisfied at least one qualifying condition for triggering a bonus feature and/or activating or modifying a multiplier), (iii) one or more user interfaces for use in a game, (iv) one or more game themes for a game and/or (v) profiles or other personal information associated with a player of a game. It should be noted that in some embodiments such data may be stored on the game server 110 and information based on such data may be output to a player device 102 during play of a game while in other embodiments a game program may be downloaded to a local memory of a player device 102 and thus such data may be stored on a player device 102 (e.g., in encrypted or other secure or tamper-resistant form).

A game server 110 may comprise a computing device for facilitating play of a game (e.g., by receiving an input from a player, determining an outcome for a game, causing an outcome of a game to be displayed on a player device, facilitating a wager and/or a provision of a payout for a game). For example, the game server 110 may comprise a server computer operated by a game provider or another entity (e.g., a social network website not primarily directed at providing games). In some embodiments, the game server may determine an outcome for game event of a game by requesting and receiving such an outcome from another remote server operable to provide such outcomes. In some embodiments, the game server 110 may further be operable to facilitate a game program for a game (e.g., a wagering game). In accordance with some embodiments, in addition to administering or facilitating play of a game, a game server 110 may comprise one or more computing devices responsible for handling online processes such as, but not limited to: serving a website comprising one or more games to a player device and/or processing transactions (e.g., wagers, deposits into financial accounts, managing accounts, controlling games, etc.). In some embodiments, game server 110 may comprise two or more server computers operated by the same entity (e.g., one server being primarily for storing states of games in progress and another server being primarily for storing mechanisms for determining outcomes of games, such as a random number generator).

Turning now to a description of a player device 102, in accordance with some embodiments a player device 102 may comprise a computing device that is operable to execute or facilitate the execution of a game program and used or useful by an player for accessing an casino or other electronic (e.g., online) game. For example, a player device 102 may comprise a computing device dedicated to gaming, a desktop computer, computer workstation, laptop, mobile device, tablet computer, Personal Digital Assistant (PDA) devices, cellular or other wireless telephones (e.g., the Apple™ iPhone™), video game consoles (e.g., Microsoft™ Xbox™, Xbox One™, Sony™ Playstation™, and/or Nintendo™ Wii™), and/or handheld or portable video game devices (e.g., Nintendo™ Game Boy™ or Nintendo™ DS™). A player device 102 may comprise and/or interface with various components such as input and output devices (each of which is described in detail elsewhere herein) and, in some embodiments, game server 110. A player device 102 may be a dedicated gaming device (e.g., a slot machine or video terminal on a casino floor) or a non-dedicated gaming device (e.g., an iPad™). It should be noted that a game server 110 may be in communication with a variety of different types of player devices 102.

A player device 102 may be used to play a wagering or non-wagering game (e.g., a baccarat game) over a network and output information relating to the game to players participating in the game (e.g., outcomes for an event instance of the game, qualifying for a bonus multiplier features of the game, current multiplier value player has qualified for, outcomes determined for a bet, a result of a bet, credit balance of credits available for play of the game, etc.). Any and all information relevant to any of the aforementioned functions may be stored locally on one or more of the player devices 102 and/or may be accessed using one or more of the player devices 102 (in one embodiments such information being stored on, or provided via, the game server 110). In another embodiment, a player device 102 may store some or all of the program instructions for determining, for example, (i) that an event instance or game instance (e.g., a dealing of cards for a baccarat game) has been triggered or initiated (and, in some embodiments, communicating such a trigger or initiation to game server 110), (ii) a result for a bet (e.g., which may comprise the payout won as a result of the bet and/or whether a qualifying condition for activating a multiplier feature and/or modifying a multiplier value has been satisfied), and/or (iv) modifying a game interface to reflect events within the game. In some embodiments, the game server 110 may be operable to authorize the one or more player devices 102 to access such information and/or program instructions remotely via the network 104 and/or download from the game server 110 (e.g., directly or via an intermediary server such as a web server) some or all of the program code for executing one or more of the various functions described in this disclosure. In other embodiments, outcome and result determinations may be carried out by the game server 110 (or another server with which the game server 110 communicates) and the player devices 102 may be terminals for displaying to an associated player such outcomes and results and other graphics and data related to a game.

It should be noted that the one or more player devices 102 may each be located at the same location as at least one other player device 102 (e.g., such as in a casino or internet café) or remote from all other player devices 102. Similarly, any given player device may be located at the same location as the game server 110 or may be remote from the game server 110. It should further be noted that while the game server 110 may be useful or used by any of the player devices 102 to perform certain functions described herein, the game server 110 need not control any of the player devices 102. For example, in one embodiment the game server 110 may comprise a server hosting a website of an online casino accessed by one or more of the player devices 102.

In one embodiment, a game server 110 may not be necessary or desirable. For example, some embodiments described in this disclosure may be practiced on one or more player devices 102 without a central authority. In such an embodiment, any functions described herein as performed by a game server 110 and/or data described as stored on a game server 110 may instead be performed by or stored on one or more player devices 102. Additional ways of distributing information and program instructions among one or more player devices 102, a game server 110 and/or another server device will be readily understood by one skilled in the art upon contemplation of the present disclosure.

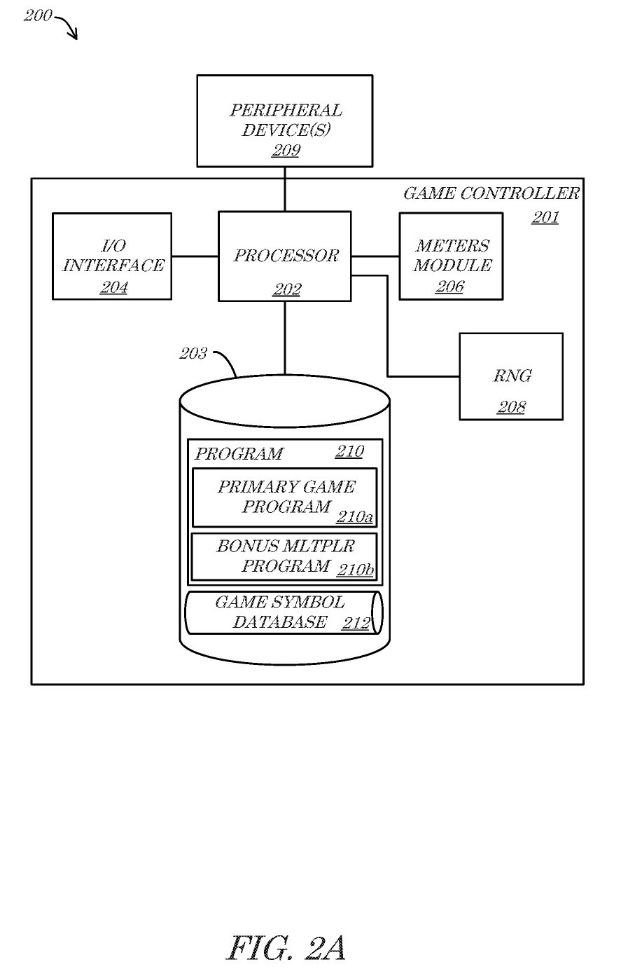

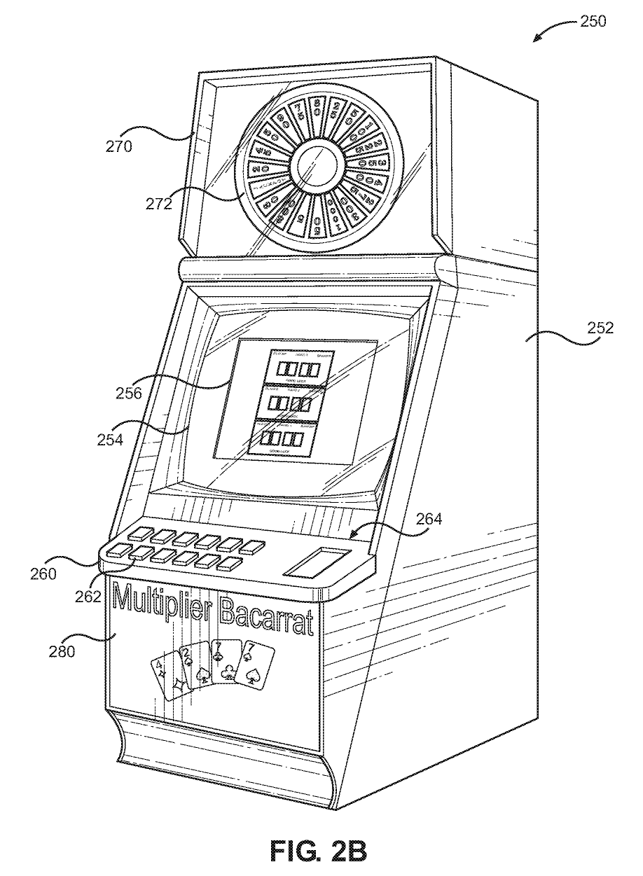

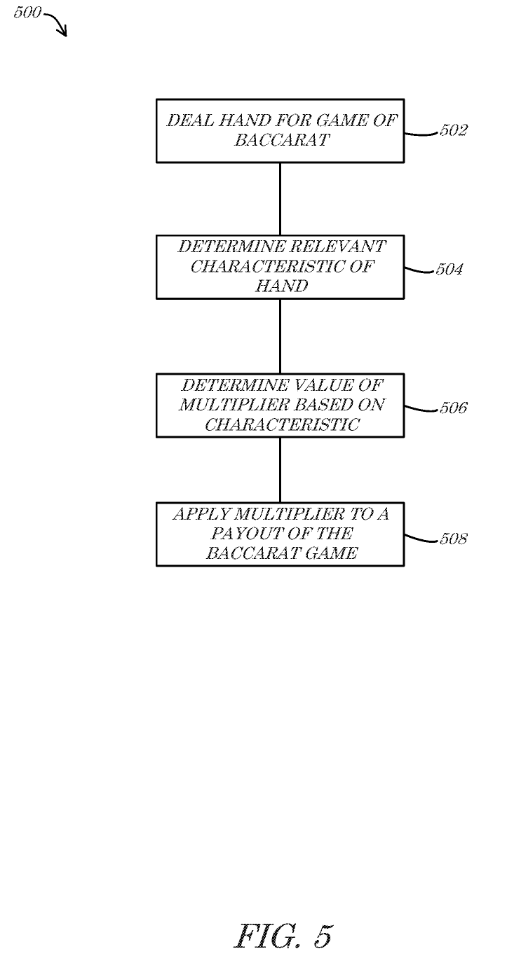

Referring now to FIG. 2A, illustrated therein is a block diagram of a gaming apparatus 200 according to some embodiments. In some embodiments, the gaming apparatus 200 may be similar in configuration and/or functionality to any of the player devices 102 (FIG. 1), gaming apparatus 250 (FIG. 2B), the game server 110 (FIG. 1) and/or another device operable to facilitate the embodiments described herein. The gaming apparatus 200 may, for example, execute, process, facilitate, and/or otherwise be associated with any of the processes described herein (e.g., process 500 of FIG. 5). In some embodiments, gaming apparatus 200 comprises a dedicated gaming device, such as a console on a casino floor or a handheld console for playing a game consistent with at least some embodiments described herein. In other embodiments, gaming apparatus 200 may comprise a non-dedicated gaming device, such as a personal computer or mobile device (e.g., smartphone) via which a player may play a game consistent with at least some embodiments described herein. In yet other embodiments, gaming apparatus 200 may comprise a server device operable to facilitate a game consistent with embodiments described herein and operable to output information of the game and receive input from the player (e.g., wager selection, request for initiation of a new game event) via GUI output to a remote player device (e.g., via a web browser of the player device).

The gaming apparatus 200 comprises a game controller 201, which may be a combination of specialized software and/or hardware which together operate to facilitate an electronic baccarat game in accordance with at least some embodiments described herein. In accordance with some embodiments, the game controller 201 includes at least one processor 202. Instructions and data to control operation of the processor 202 in accordance with at least some embodiments may be stored in a memory 203. Processor 202 may be operable to communicate with memory 203 in order to implement functionality described herein. The gaming apparatus also includes an input/output (I/O) interface 204, meters module 206 and/or a Random Number Generator (RNG) 208.

Fewer or more components and/or various configurations of the components 202, 203, 204, 206 and/or 208 may be included in the gaming apparatus 200 without deviating from the scope of embodiments described herein. At least some of the components 202, 203, 204, 206 and/or 208 may be located outside of the game controller 201 in some embodiments. In some embodiments, at least some of the components of the gaming apparatus 200 may be distributed. For example, one or more of the components 202, 203, 204, 206 and 208 may be provided remotely from the game controller 201 and/or gaming device 200.

In some embodiments, the gaming apparatus 200 may additionally comprise any type or configuration of communication device (not shown) that is or becomes known or practicable. For example, the gaming apparatus 200 may include a communication device such as a Network Interface Controller (NIC), a telephonic device, a cellular network device, a router, a hub, a modem, and/or a communications port or cable. In some embodiments, the communication device may be coupled to provide data to a telecommunications device. The communication device may, for example, comprise a cellular telephone network transmission device that sends signals (e.g., an initiation of an event instance) to a server (e.g., game server 110) in communication with a plurality of player devices 102. According to some embodiments, the communication device may also or alternatively be coupled to the processor 202. In some embodiments, the communication device may comprise an IR, RF, Bluetooth™, and/or Wi-Fi® network device coupled to facilitate communications between the processor 202 and another device.

According to some embodiments, the processor 202 may be or include any type, quantity, and/or configuration of processor that is or becomes known. The processor 202 may comprise, for example, an Intel® IXP 2800 network processor or an Intel® XEON™ Processor coupled with an Intel® E7501 chipset. In some embodiments, the processor 302 may comprise multiple inter-connected processors, microprocessors, and/or micro-engines. According to some embodiments, the processor 202 (and/or the gaming apparatus 200 and/or other components thereof) may be supplied power via a power supply (not shown) such as a battery, an Alternating Current (AC) source, a Direct Current (DC) source, an AC/DC adapter, solar cells, and/or an inertial generator. In some embodiments (e.g., in an embodiment in which the gaming apparatus 202 comprises a server such as a blade server), necessary power may be supplied via a standard AC outlet, power strip, surge protector, and/or Uninterruptible Power Supply (UPS) device.

In some embodiments, the components 203, 204, 206 and/or 206 may be communicatively coupled to the processor 202 (e.g., via wired and/or wireless connections and/or pathways) and they may generally comprise any types or configurations of I/O, meters, memory and RNG components and/or devices that are or become known, respectively.

The memory device 203 may comprise any appropriate information storage device that is or becomes known or available, including, but not limited to, units and/or combinations of magnetic storage devices (e.g., a hard disk drive), optical storage devices, and/or semiconductor memory devices such as Random Access Memory (RAM) devices, Read Only Memory (ROM) devices, Single Data Rate Random Access Memory (SDR-RAM), Double Data Rate Random Access Memory (DDR-RAM), Programmable Read Only Memory (PROM) and/or Erasable Programmable Read-Only Memory (EPROM). Other examples of types of information storage devices which may be utilized include Magnetoresistive Random Access Memory (MRAM), flash RAM, Dynamic Access Memory (DRAM), Static Random Access Memory (SRAM), flash memory and ferroelectric memory (F-RAM).

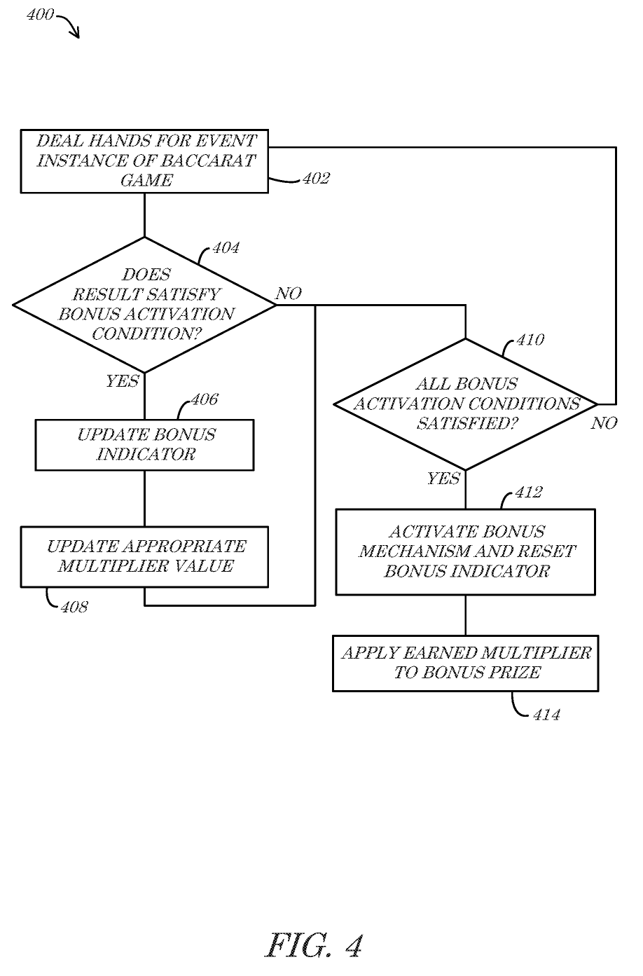

The memory device 203 may, according to some embodiments, store a program 210 for facilitating one or more of the embodiments described herein, which program may include a primary game program 210a for facilitating a primary aspect of a game and a bonus multiplier program 210b for facilitating a bonus multiplier feature of the game, which may be relevant to some embodiments. The memory device 203 further stores a game symbols database 212, which may store individual game symbols (e.g., representations of individual cards for a baccarat game) or sets of symbols (e.g., representations of possible hands of cards, to place along a payline of the game). In some embodiments, game symbol database 212, the primary game program 210a and/or the bonus multiplier program 210b may be utilized by the processor 202 to provide output information via a GUI (e.g., such as GUI 400 of FIG. 4), to show to a player progress in a game event.

In some embodiments, additional programs or software modules may be stored in memory device 208 or otherwise accessible to processor 202. In some embodiments, one or more of the primary game program 210a and the bonus round program 210b may comprise various sub-programs, sub-routines or software modules for facilitating different functionality. For example, any of an additional program, program 210a and/or program 210b may be a stand-alone program or may be part of a program, or set of programs providing various services to a user. For example, the gaming apparatus 200 may be facilitating a game event and within a program 210a or 210b, one or more sections or modules may be provided to facilitate a (i) determining a result for a baccarat game instance; (ii) determining whether a value of a multiplier is to be modified based on a result of a baccarat hand; (iii) determining whether a multiplier should be applied to a payout for a baccarat hand; (iv) determining whether a qualifying condition for activating a bonus feature has been satisfied and/or (v) determining whether a bonus feature should be activated due to the at least one qualifying condition(s) being satisfied; which program section(s) or module(s) may be executed at a relevant time. In some embodiments, the memory device 203 may store an additional program which is called by the primary game program 210a or the bonus multiplier program 210b when required such that the same additional program can be used by multiple programs. For example, the memory device 203 may store a “game engine” program to provide core services which are utilized by a number of individual game programs to save duplication of software code.

The memory device 203 may, in accordance with some embodiments, comprise different types of memory such as RAM, EPROM and/or a mass storage device. Different types of memory may be utilized for different purposes. For example, (i) RAM may be utilized to temporarily hold program files for execution by the processor 202 and related data; (ii) EPROM may be a boot ROM device and/or may contain some system or game related code; and (iii) a mass storage device may be used to store game programs, the integrity of which may be verified and/or authenticated by the processor 202 (e.g., by use of a program stored in another type of memory, such as in EPROM memory).

The I/O interface 204 may, in accordance with some embodiments, provide for communicating with a player interface (e.g., a GUI such as GUI 400 of FIG. 4) and/or one or more peripheral devices of gaming apparatus 200 (in some embodiments, one or more of the peripheral devices may be components of the player interface and the I/O interface 204 may communicate with such devices indirectly, via the player interface). In accordance with some embodiments, the I/O interface 204 and/or peripheral devices of the gaming apparatus 200 may be intelligent devices with their own memory for storing associated instructions and data for use with the player interface or the peripheral devices.

In accordance with one embodiment, the I/O interface 204 may provide for communication with an input device of the gaming apparatus 200. Such an input device may comprise, for example, a keyboard or bank of user-actuatable selector mechanisms or buttons that allow an operator of the gaming apparatus 200 to interface with the gaming apparatus 200 (e.g., by a player, an employee or other worker affiliated with either an online casino or other entity operating a system which provides games to players). In some embodiments, such an input device may comprise a mechanism configured to indicate to a remote server device an initiation or triggering of an event instance (e.g., that a player has actuated a “deal” mechanism (e.g., a “soft” or virtual button on an online game interface) and thus initiated a game event of a baccarat game), such information being provided to the apparatus 200 and/or the processor 202. In such embodiments, the input device may comprise a key or button on a keyboard or panel of the gaming apparatus 200, a link or selectable area on a screen which is selectable by a mouse or other selection mechanism or a touch-sensitive screen of a device. Other examples of input devices include, but are not limited to: a game controller and/or gamepad, a bar-code scanner, a magnetic stripe reader, a pointing device (e.g., a computer mouse, touchpad, and/or trackball), a point-of-sale terminal keypad, a microphone, an infrared sensor, a sonic ranger, a computer port, a video camera, a motion detector, a digital camera, a network card, a Universal Serial Bus (USB) port, a GPS receiver, a Radio Frequency Identification (RFID or RF) receiver, a RF receiver, a thermometer, a pressure sensor, and a weight scale or mass balance.

In accordance with one embodiment, the I/O interface 204 may provide for communication with an output device of the gaming apparatus 200. Such an output device may comprise, for example, a display screen and/or other practicable output component and/or device that is operable to output information. Such an output device may, for example, comprise a display screen via which are output outcomes, instructions, guidance, questions or information to a player of a game. For example, the output device may output a game interface for a game which indicates an outcome of an event instance of the game, such as the cards dealt for at least one hand of a baccarat game and/or whether a result of the at least one hand is an increase in a value of a multiplier and/or satisfaction of a qualifying condition for activating a bonus multiplier feature. In some embodiments, the output device may output two distinct game interfaces (e.g., one above the other or one next to the other). For example, one game interface may be for outputting information regarding a primary game of baccarat (e.g., element positions defining at least one hand of baccarat) and another game interface may be for outputting information regarding a multiplier bonus feature (e.g., a bonus wheel and progress towards activating it).

Some additional examples of output devices that may be useful in some embodiments include a Cathode Ray Tube (CRT) monitor, a Liquid Crystal Display (LCD) screen, a Light Emitting Diode (LED) screen, a printer, an audio speaker, an Infra-red Radiation (IR) transmitter, an RF transmitter, and/or a data port. According to some embodiments, an input device and an output device may comprise and/or be embodied in a single device such as a touch-screen display or screen.

The meters module 206 may comprise software and/or hardware operable to track and report on player credit with respect to the gaming apparatus 200. Such information may be desirable to track for various purposes such as ensuring regulatory compliance and determining profitability of the gaming apparatus.

The RNG 208 may comprise hardware and/or software operable to generate and/or store random or pseudo-random numbers for use by the processor 202. For example, as described herein, processor 202 may determine a random or pseudo-random number for use in determining which game elements to place into the game element positions of a game interface in order to indicate a result of a game event. In some embodiments a single random or pseudo-random number may be determined and used for a particular game instance which includes a plurality of hands while in other embodiments an individual random or pseudo-random number may be determined and used for each hand of a game instance which includes a plurality of hands. For example, in one embodiment RNG 208 comprises an algorithm which generates random or pseudo-random numbers for use in the game. In other embodiments, gaming apparatus 200 may not include a local RNG and processor 202 may instead obtain random or pseudo-random numbers from a remotely located RNG (e.g., an RNG located at a remote server with which gaming apparatus is operable to communicate).

The gaming apparatus 200 may function as a computer terminal and/or server of an online casino or other entity operating to provide online games, receive and/or manage information related to online games. In some embodiments, the gaming apparatus 200 may comprise an apparatus that is operable to interact with a player of an online game. In some embodiments, gaming apparatus 200 may comprise a plurality of devices working together to accomplish the functionality described herein with respect to FIG. 2A.

Any or all of the exemplary instructions and data types described herein and other practicable types of data may be stored in any number, type, and/or configuration of memory devices that is or becomes known. The memory device 203 may, for example, comprise one or more data tables or files, databases, table spaces, registers, and/or other storage structures. In some embodiments, multiple databases and/or storage structures (and/or multiple memory devices 203) may be utilized to store information associated with the gaming apparatus 200. According to some embodiments, the memory device 203 may be incorporated into and/or otherwise coupled to the gaming apparatus 200 (e.g., as shown) or may simply be accessible to the apparatus 200 (e.g., externally located and/or situated).

In some embodiments, the game controller 201 may further be operable to communicate with one or more peripheral devices 209. Examples of such peripheral devices include displays, touch screens, a bank of physical buttons of a gaming console, a card and/or ticket reader, a printer, a bill acceptor and/or coin input mechanism, and a currency output mechanism.

In some embodiments, gaming apparatus 200 may include additional components such as a communications interface which functions to allow the gaming apparatus 200 to communicate with other components of a gaming system. For example, the gaming apparatus 200 may include a network card. The network card may, for example, send to and/or receive from another device information, instructions and/or data. Such information, instructions and/or data may relate to, for example, status (e.g., of a player and/or game) or accounting (e.g., for a particular player and/or the gaming apparatus 200). Such other device may comprise, for example, a specialized server device of a casino operator. Additional hardware may be included as part of the gaming apparatus, or hardware may be omitted, as desired for the specific implementation.

Referring now to FIG. 2B, illustrated therein is an example gaming apparatus 250, which comprises an example of a player device embodied as a dedicated gaming apparatus, such as may be found on a casino floor, which may specially function to provide at least some of the embodiments described herein. In one embodiment, gaming apparatus 250 comprises a player device 102 (FIG. 1) and/or gaming apparatus 200 (FIG. 2A).

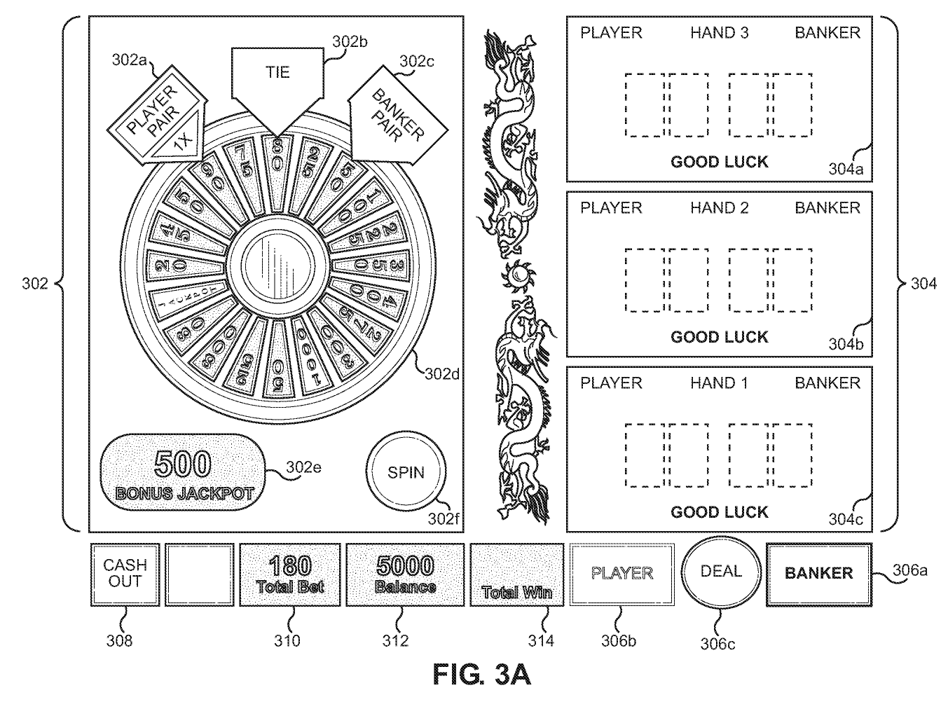

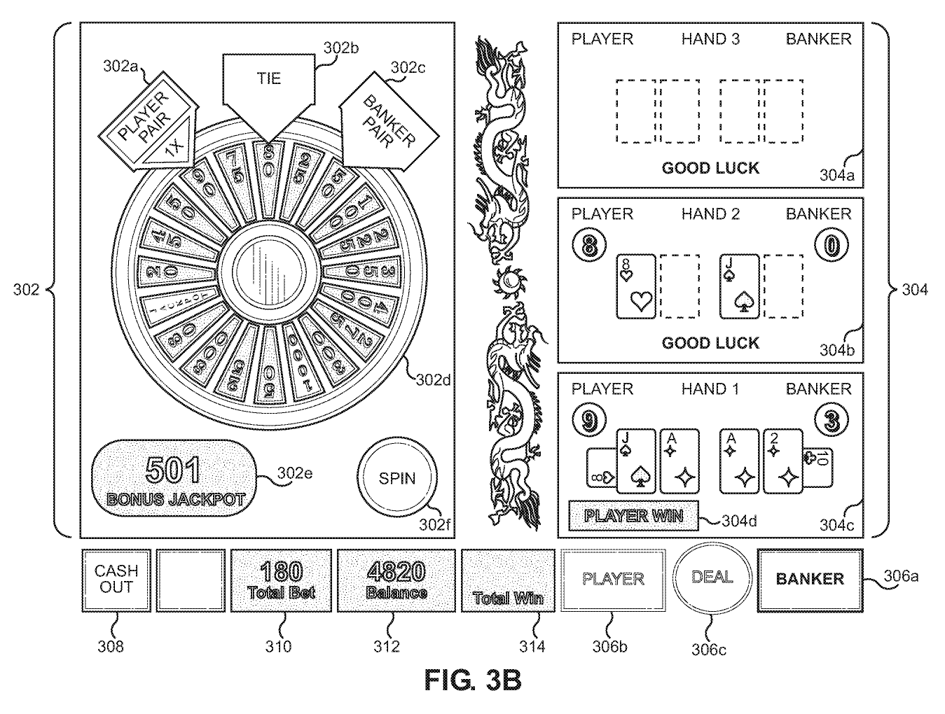

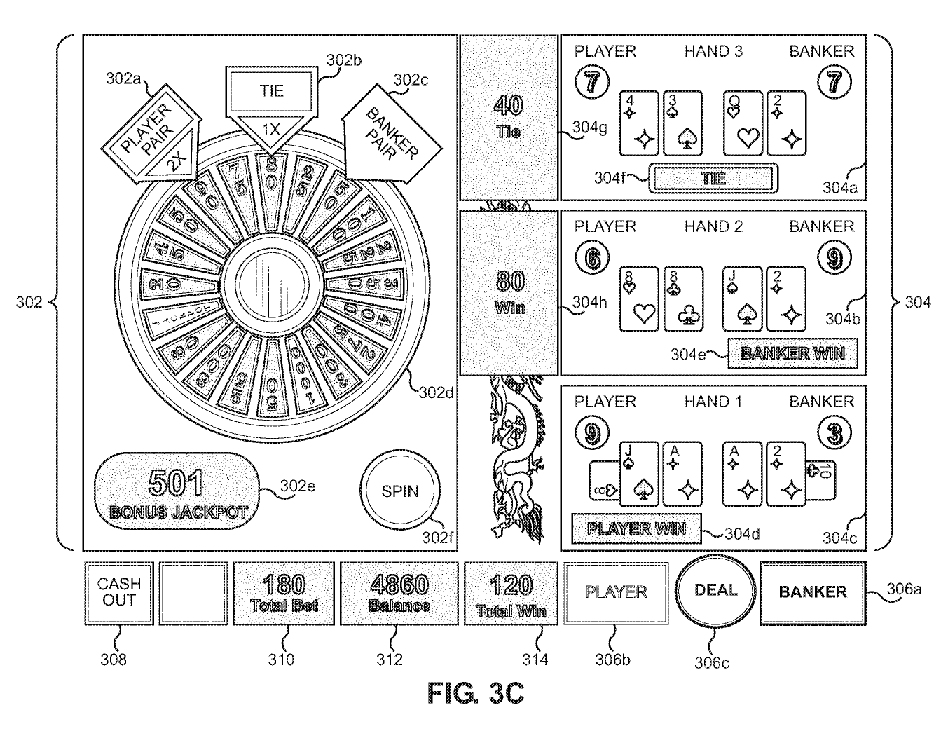

In accordance with some embodiments, the gaming apparatus 250 may include a console 252 having a display 254 on which is displayed in area 256 a representations of a primary game of baccarat that can be played by a player in accordance with the embodiments described herein. In the example of FIG. 2B, the game interface of the primary game being displayed in area 256 corresponds to the primary game depicted in area 304 of GUI 300 (FIGS. 3A-3C).

The display 254 may, in some embodiments, comprise a touch screen operable to receive input from a player. In accordance with some embodiments, one or more areas of a GUI output to a player may comprise respective input mechanisms, such as interactive virtual buttons on a touch screen which allow a player to make selections or provide input to the game. In accordance with some embodiments, the display 254 may be operable to output a GUI such as the example GUI 300 illustrated in FIGS. 3A-3C.

Section 260 of the gaming apparatus 250 includes a set of input mechanisms a bank of buttons 262. Mechanical buttons 262 comprise another example input mechanism for enabling a player to interact with the gaming apparatus (e.g., to provide selections or input during game play, such as selection of a wager and/or request for an initiation of a new game instance or dealing of at least one hand into a game interface). Mechanical buttons 262 may be used in place of or in addition to input mechanisms on a touch screen. Section 260 may also, in some embodiment, include at least one monetary input mechanism 264 for allowing a player to input currency, credit or other information (e.g., financial account information) in order to establish funds with the gaming apparatus such that the player may wager on the game playable on the gaming apparatus 250. For example, the at least one monetary input mechanism 264 may comprise at least one of (i) a coin input chute; (ii) a bill collector; (iii) a card reader for reading a smart card, debit card or credit card; (iv) am RFID reader device for reading information from an RFID-enabled currency mechanism of the player (e.g., an RFID-enabled credit or debit card, an RFID-enabled portable memory device which stores fund information for the player, etc.); and (v) a ticket-in/ticket-out mechanism for receiving and/or outputting printed receipts or other printed media which a player may utilize to establish funds with the gaming apparatus. In some embodiments, section 260 may further include other components, such as a reading device operable to read a player tracking card or other device (e.g., a magnetic stripe card, flash drive or any other portable storage medium capable of being read by the reading device).

A top portion 260 of the gaming apparatus 250 may output or have displayed thereon, in area 272, artwork or information regarding the game. In the particular embodiment of FIG. 2B, area 272 is being utilized to output a representation of a bonus awarding mechanism comprising a wheel, consistent with some embodiments described herein and corresponding to the example bonus awarding mechanism included in area 302 of GUI 300 (FIGS. 3A-3C). Additional information and/or artwork may be displayed or output on a front panel 280 of the console 252. In some embodiments, the console 252 may include additional components not illustrated in FIG. 2B. For example, console 252 may include a coin tray, a ticket or receipt printer and/or a bill dispenser.

Referring now to FIGS. 3A-3C, illustrated therein and consistent with some embodiments is a graphical user interface (GUI) 300, as it may be modified during a session and over a plurality of consecutive game instances or wagering events. The graphical user interface 300 is arranged to display information regarding a program, software application or other element associated with a computing device. In accordance with one embodiment, the GUI 300 is associated with a program comprising one or more sub-routines, modules or functions. In one embodiment, GUI 300 is associated with a program for facilitating an electronic baccarat game consistent with at least some embodiments described herein and playable by a user via a player device (e.g., a dedicated player device such as that illustrated in FIG. 2B or a non-dedicated player device such as a smart phone or tablet computer). For example, GUI 300 may be associated with program 210 (FIG. 2A), as described in more detail herein. In one more specific example, in some embodiments a player device may access a server device as a client via a browser on the player device and the player may play a game consistent with at least some embodiments described herein by accessing the game interface using a browser rather than having game logic downloaded to the player device. Thus, in some embodiments GUI 300 may comprise a game interface output in a display of a player device via a web browser of the player device, the information displayed therein being modified by a server device of a game provider.

In accordance with some embodiments, GUI 300 may be arranged to display information associated with a program for facilitating an electronic baccarat game consistent with at least some embodiment described herein and permit interaction with (e.g. provide input to the program), whether directly or indirectly, the computing device which is running or performing the program. In one embodiment, the GUI 300 comprises a mechanism for one or more computing devices to output game data to a player via a display of a player device (e.g., by displaying the GUI 300 via a web browser of the player device) and/or receive data from a player, and thereby perform one or more programs or sub-routines for facilitating an electronic baccarat game comprising a bonus multiplier feature. For example, some elements of the GUI 300 may comprise input mechanisms (e.g., virtual buttons or links actuatable by the player via a cursor or via a touch if the GUI 300 is being displayed via a touchscreen of a player device) and the inputs provided by the player to the GUI 300 may be transmitted to the computing device (e.g., gaming apparatus 200) which is operable to determine data and progress in the game based on the inputs (e.g., a computing device operable to perform at least one of process 400, process 500 and process 600, described herein with reference to FIGS. 4, 5 and 6).

In accordance with one embodiment, GUI 300 may comprise a plurality of windows or areas of a variety of shapes and sizes (which shapes and sizes may be modified during a course of a game event, to allow for clearer representations of information to a player). In the example of FIGS. 3A-3C, GUI 300 includes a first window 302 comprising a bonus feature display area, in which there is displayed a bonus awarding mechanism embodied as a wheel 302d having various available bonus prizes displayed on wedges of the wheel. Also displayed in window 302, along the circumference of the wheel, are three (3) pointers 302a, 302b and 302c, each indicating a respective qualifying condition which must be satisfied in order for the bonus awarding mechanism comprising the wheel to be activated. In the embodiment of FIGS. 3A-3C, each of the three qualifying conditions must be satisfied in order for the wheel to be activated. Each of the pointers 302a, 302b and 302c, consistent with one embodiment, includes an area (in the triangular part of each pointer) for displaying a multiplier value corresponding to that pointer. In accordance with one embodiment, each time a particular qualifying condition is satisfied, the value of the multiplier on the pointer corresponding to that qualifying condition is increased. In the example of FIG. 3A, thus far in the session being illustrated only pointer 302a has a multiplier value displayed thereon (indicating that the qualifying condition corresponding to this pointer has already been satisfied during the current session).

In the embodiment of FIGS. 3A-3C, the three (3) qualifying conditions are: (i) a Player Pair being obtained in a hand of a primary baccarat game; (ii) a Banker Pair being obtained in a hand of the primary baccarat game; and (iii) a Tie being obtained in a hand of the primary baccarat game. In accordance with some embodiments, each such qualifying condition must be obtained in a single session of play of the primary baccarat game (e.g., from a time a player starts playing the baccarat game to a time the player starts playing the baccarat game, with not more than a maximum allowed pause in game play). Of course, more, fewer and/or different qualifying conditions may be implemented and the number and type of qualifying conditions illustrated in FIGS. 3A-3C are for illustrative purposes only.

In accordance with some embodiments, the window 302 comprising the bonus feature area further includes a progressive top jackpot amount displayed in sub-area 302e and a spin button 304f. In accordance with some embodiments, the baccarat game may include an increasing or progressive top jackpot for the bonus feature and area 302e may be updated to indicate the current top jackpot amount. In accordance with one embodiment, a player may win this top jackpot amount if the wheel 302d is activated, spun using the spin button 304f, and at the resolution of the wheel spin one of the pointers 302a, 302b or 302c is pointing to the wedge of the wheel marked as “jackpot.” In some embodiments, a game provider may place a maximum on the progressive jackpot amount or place other restrictions on a win of the progressive jackpot amount (e.g., a maximum multiplier value which may apply to the progressive jackpot amount but not to other bonus prize amounts). It should be noted that in some embodiments, the different wedges of the bonus wheel 302d may be weighted differently such that there is more or less of a probability of a pointer landing on a particular prize amount upon a resolution of the bonus wheel 302d (e.g., the progressive jackpot wedge may be weighted such that it has the least probability of being won).

In accordance with some embodiments, the spin button 3002f only becomes activated or available to the player once all the qualifying condition(s) indicated on the pointers 302a, 302b and 302c are satisfied or some other qualifying condition is satisfied. Once a player initiates a spin of the bonus wheel 302d by actuating the Spin button 302f, an output from an RNG or other source may be obtained and utilized to determine the result of the spin (i.e., which wedges the three pointers 302a, 302b and 302c should land on once the wheel stops spinning).

Also included in the example GUI 300 of FIGS. 3A-3C is an area 304 for displaying information pertaining to the primary game of baccarat. In accordance with some embodiments, in the primary game of baccarat three hands of baccarat are dealt for each wager or game instance. Thus, area 304 includes a sub-area or row for each hand: 304a, 304b and 304c. Each sub-area 304a, 304b and 304c includes four symbol positions for placement of up to four cards into each hand of baccarat. In accordance with some embodiments, the two element positions on the left correspond to the Player side of the hand and the two element positions on the right correspond to the Banker side of the hand. In some embodiments (and as illustrated in hand 304c of FIGS. 3B and 3C), in some circumstances up to six cards may be dealt per hand (e.g., three corresponding to the Player side and three corresponding to the Banker side). Of course, any number of hands may be implemented as being dealt for a given wager and the embodiments described herein are not dependent on any particular number of hands being dealt per wager.

The GUI 300 further includes a button 306a via which a player may select a Banker side for a given wager, a button 306b via which the player may select a Player side win for a given wager and a “Deal” button 306c via which the player may request a dealing of new hands for a new game instance of a baccarat game. In FIG. 3A in particular, it is illustrated that the player has selected the Banker side for the current wager (i.e., the player is wagering that the Banker side of each hand will win), as indicated by the darker font and border shown for the button 306a (with the non-selected Player side button 306b being shown as grayed-out or faded).

Area 308 comprises a “cash out” button via which a player may request to cash out his credits and end a current session of play. Area 310 indicates the total amount being wagered by the player on the current game instance. In accordance with some embodiments in which a plurality of hands are dealt for a given game instance, a total bet or amount wagered may be split evenly among the hands. Thus, for example, in the embodiment of FIG. 3A, the 180 credits being wagered on the current game instance may be distributed evenly among the three hands such that a sixty (60) credit wager is attributed to each of the three hands of areas 304a, 304b and 304c. Of course the total amount wagered may be distributed in various manners among a plurality of hands, either by the system or (in some embodiments) by the player and the embodiments described herein are not dependent on any particular manner of distributing a total amount wagered among a plurality of hands.

Area 312 indicates the amount of funds (or credit meter balance) the player currently has as available for wagering on the electronic baccarat game. In accordance with some embodiments, each time a player actuates the “Deal” button 306c, the amount of the wager for the new game instance being initiated is deducted from the amount of funds indicated in area 312 (and that wager amount is indicated in area 310). As described herein, one mechanism for populating a symbol matrix may comprise populating a single card into each symbol position of the matrix upon a game initiation event (e.g., a player actuates a “deal” command in a game interface of the game). In such an embodiment, some or all of the cards placed into symbol positions may initially be dealt face-down. In some embodiments, the values of the face-down cards may be revealed (e.g., the cards may be virtually flipped over) initially only for a sub-set of the cards (e.g., for the first two cards of each side). As also described herein, in some embodiments not all symbol positions may initially be populated. For example, in one embodiment only two of the three symbol positions attributable to a player side and two of the three symbol positions attributable to the banker side for a given hand may initially be populated (e.g., an additional third card may be added to the third available position of each hand if the player or game rules provide for a dealing of the third card).

Area 314 indicates a total amount won as a result of the primary hand, by summing any payouts won for each of the plurality of hands shown in areas 304a, 304b and 304c. At the stage of the primary game being illustrated in FIG. 3A, no cards have yet been dealt into any of the hands such that no determination of a payout for any of the hands has yet been made and thus area 314 does not indicate any payout amount.

A “button”, as this term is used in describing certain areas or aspects of a GUI, may comprise a player-selectable mechanism via which a player may provide input. For example, the button 306a is for selecting the Banker side as the side the player would like to wager on for purposes of the present game event. A player-selectable mechanism or button may comprise, for example, touch-sensitive areas on a touch screen or areas selectable via a cursor and mouse mechanism of a player device. In one embodiment in which a player device comprises a dedicated gaming device, the player-selectable mechanisms for making selections or providing input may be embodied as physical buttons in a bank of buttons of a console comprising the gaming device.

Referring to FIG. 3B, illustrated therein is GUI 300 as it may appear after a game session progresses from that illustrated in FIG. 3A. In particular, FIG. 3B shows that for the game instance initiated in FIG. 3A, cards have been dealt to the hand in area 304c and that this hand has resulted in a Player side win. Area 304c indicates the Player side win and shows the point value for each of the Player side of the hand (“9”) and the Banker side of the hand (“3”). Since (as indicated via the bolded nature of Banker side button 306a) the player has wagered that the Banker side would win for the current game instance, the player does not win a payout as a result of the hand in area 304c. However, it should be noted that, in accordance with some embodiments, the player may still advance towards activating the bonus wheel in area 302 by having the outcome of a hand satisfy a qualifying condition for activating a bonus feature even if the player does not win a payout as a result of that hand (i.e., if the game elements in the hand satisfy a qualifying condition, which in the present example consist of a Player Pair, a Banker Pair or Tie). In other embodiments, an outcome of a hand may only count towards satisfying a qualifying condition if the player wins a payout as a result of that hand. In the example being illustrated in FIG. 3B, the hand dealt into area 304c does not satisfy any of the three qualifying conditions for activating the bonus wheel of area 302. FIG. 3B also shows that some cards have been dealt into the hand shown in area 304b. It should be noted that in some embodiments all the cards for each of the plurality of hands may be dealt or output simultaneously.

Turning now to FIG. 3C, illustrated therein is how the game instance of the present example has progressed since that illustrated in FIG. 3B, such that all the cards dealt to the hand in area 304b and to the hand in area 304a are now shown. As illustrated in area 304b, the point value for the Player side of this hand is “6” and the point value for the Banker side of this hand is “9”, thus resulting in a Banker side win. Since the player has bet on the Banker side, the player wins a payout as a result of this hand (as indicated in the window to the left of area 304b, which indicates a eighty (80) credit win for this hand). Further, since the hand in area 304b also includes a Player Pair, which is one of the qualifying conditions for activating the bonus wheel 302d, the pointer 302a which corresponds to the Player Pair qualifying condition has been modified to indicate a multiplier of 2× rather than 1× (as it had indicated in FIG. 3A, prior to another Player Pair having been obtained in the session).

As illustrated in area 304a, the point value for both the Player side and the Banker side of this hand is “7”, thus resulting in a Tie. In accordance with the rules of the example primary game illustrated in FIGS. 3A-3C, the player wins a payout as a result of this Tie (as indicated in the window to the left of area 304a, which indicates a forty (40) credit win for this hand). Thus, as indicated in area 312, the particular game instance being illustrate in FIGS. 3A-3C has resulted in a total payout of 120 credits for the player (which is still a net loss for the game instance, considering the player wagered a total of 180 credits on the game instance).

As described, in accordance with the example embodiment of FIGS. 3A-3C, a Tie is one of the bonus activating conditions which must be satisfied in order for the bonus wheel in area 302 to be activated. Since the hand in area 302a resulted in a Tie, this bonus activating condition has been satisfied. Thus, the pointer 302b in area 302 has been modified to indicate that this corresponding condition has been satisfied (as indicated by the “1×” multiplier which now appears in the pointer 302b, as well as the modified appearance of pointer 302b). Of course various mechanisms may be utilized for indicating to a player that a qualifying condition has been satisfied and the particular manner of modifying an appearance of a pointer illustrated in FIG. 3C is intended as an example only. As indicated in FIG. 3A, the qualifying condition “Player Pair” had been satisfied in a previous game instance of the current session. Thus, the player has now satisfied two (2) of the three (3) qualifying conditions required for activating the bonus wheel 302d. This may motivate the player to continue the current session in order to try and satisfy the third qualifying condition and win a bonus, even if the player is considering ending his current gaming session.

As described herein, in some embodiments the multiplier associated with a given qualifying condition may be increased by a predetermined value each time that qualifying condition is satisfied in a given session. This increase may, in some embodiments, be capped at some maximum multiplier value (e.g., as set by a gaming device operator or game provider).

In accordance with some embodiments, populating the symbol matrix with cards (i.e., placing symbol elements comprising representations of cards into symbol positions of a game interface) may comprise populating the symbol matrix based on data associated with at least one of (i) live game play data; (ii) historical game play data; and (iii) an RNG. In accordance with some embodiments, each hand of cards may be associated with at least one of its own electronic shoe of cards or its own RNG or RNG output. In accordance with some embodiments, evaluating each hand may comprise determining a first sum point value for the cards in the first subset of symbol positions of the hand, determining a second sum point value for the cards in the second subset of symbol positions of the hand and determining a win for the side corresponding to the higher of the first sum point value and the second sum point value.

Referring now to FIGS. 4-5, illustrated therein are respective processes 400 (with respect to FIG. 4) and 500 (with respect to FIG. 5), each process for implementing some of the embodiments described herein. Any of the processes 400 and 500 may be performed, for example, by at least one of a server device operable to facilitate an electronic baccarat game and/or a player device enabling a player to play the electronic baccarat game. For example, any of the processes 400, 500 and 600 may be performed by at least one of (i) a player device 102 (FIG. 1); (ii) a game server 110 (FIG. 1); (iii) a player device 202 (FIG. 2A); and (iv) a player device 250 (FIG. 2B). It should be noted that additional and/or different steps may be added to those depicted and that not all steps depicted are necessary to any embodiment described herein. The processes 400 and 500 are example processes of how some embodiments described herein may be implemented, and should not be taken in a limiting fashion. A person of ordinary skill in the art, upon contemplation of the embodiments described herein, may make various modifications to either of the processes 400 and 500 without departing from the spirit and scope of the embodiments in the possession of applicant.

Referring now to FIG. 4 in particular, process 400 will be described with reference to FIGS. 3A-3C, which comprises an example GUI 300 which may be output to a player in accordance with some embodiments described herein and facilitate the implementation of process 400.

Process 400 begins in step 402 with the dealing of at least one hand for a primary game of baccarat. Step 402 may be triggered upon, for example, detecting a placement of a baccarat wager and selection by the player of the Banker or Player side and/or determining that a player has actuated a “deal” mechanism for the baccarat game. For example, step 402 may comprise determining that a player has selected a wager amount, has selected (via a player-selectable mechanism) one of the Player or Banker side and has actuated a mechanism for initiating the dealing of the cards (e.g., determination of the cards to be placed into the symbol matrix for the game instance). In some embodiments, selection of the Player side and Banker side and initiation of the dealing of cards may comprise one input (e.g., the actuation of either a “Player” button or a “Banker” button may cause cards to be dealt into the symbol matrix). Various manners of receiving an indication of a wager placement by a player are known and need not be described in detail herein.

In accordance with some embodiments, step 402 may also comprise or be preceded by receiving at least one output from an RNG, for purposes of determining a result for the wager. In one embodiment, a different number or other output from an RNG may be received for each hand and/or symbol position of a given hand. In other embodiments a single number or other output may be received from the RNG for the game instance and used to determine particular cards or other symbols to place into the symbol matrix (i.e., for all of the hand(s)) to indicate the result corresponding to the number or output for the given game instance. An output of an RNG may comprise a random or pseudo-random number or output determined based on an algorithm. In some embodiments the RNG may be a component of a gaming apparatus or other computing device performing at least some steps of process 400 while in other embodiments it may be a component of another device. For example, upon determining that a new wager has been placed, the apparatus performing process 400 may be programmed to request at least one output from an RNG, whether local or remote. As described herein, in some embodiments an electronic shoe and/or live game play data may be used in place of an RNG to determine at least one output based upon which the particular cards to place into the symbol matrix of the game are determined.

In accordance with some embodiments step 402 may further comprise selecting particular game symbols (e.g., particular images of cards) and placing them into the symbol positions of the symbol matrix based on the one or more RNG outputs. In some embodiments all six symbol positions of at least one given payline may initially be populated while in other embodiments only a subset of the symbol positions of a given hand may initially be populated (e.g., four of the six symbol positions of at least one of the hand may be populated). In embodiments in which only a subset of the symbol positions of a given hand is initially populated, if it is later determined that another symbol is to be placed into a symbol position of that hand, another output from an RNG or other source may be requested and the appropriate symbol to place may be determined based thereon.

In some embodiments step 402 (or another step in process 400) may comprise evaluating the dealt hand to determine which of the Player side and the Banker side wins (or whether the hand results in a Tie) and/or a payout won by the player as a result of the hand. For example, as described herein, in some embodiments each hand includes at least two cards attributable to a Banker side and at least two cards attributable to the Player side and evaluating a hand to determine which side is the winning side may comprise determining a point value for each side in accordance with traditional baccarat rules, then comparing the values to see which is higher. It should be noted that the evaluating of the hand to determine whether the Player side wins, the Banker side wins or there is a Tie may be performed prior to any of the cards (or at least all of the cards) being revealed to the player. In other words, the gaming apparatus or other computing device performing process 400 may determine a result for the current game instance (e.g., whether the Player side wins or the Banker side wins or there is a Tie) prior to revealing the cards and/or result to the player. In some embodiments, as described herein, there may be a need to place additional cards into the symbol matrix after an initial evaluation of the paylines (e.g., to place a third card after two cards have initially been placed into at least one of the Player side or the Banker side of at least one payline). A placement of an additional card may be due to, for example, a rule of the baccarat game or to determine a bonus for use in the determination of a payout of the baccarat game. In such embodiments, process 400 may include an additional step of placing at least one additional card into the symbol matrix after an initial evaluation of the initial cards dealt to a given hand.

In step 404, it is determined whether a result of the at least one hand dealt in step 402 satisfies at least one qualifying condition for activating a bonus awarding mechanism (e.g., a bonus awarding mechanism which includes an escalating multiplier feature, in accordance with some embodiments). Activating a bonus awarding mechanism may comprise, in some embodiments, automatically initiating the bonus awarding mechanism on behalf of the player. In other embodiments activating the bonus awarding mechanism may comprise making the bonus awarding mechanism available to the player such that the player may initiate it at his/her discretion (e.g., a player-selectable mechanism such as a virtual or mechanical button may be made responsive to player input once a bonus awarding mechanism is activated). Examples of qualifying conditions which must be satisfied in order for a bonus awarding mechanism of a baccarat game to be activated include, without limitation: (i) a particular outcome being included in a hand (e.g., a Player Pair); (ii) a particular card or combination of cards being dealt to a hand (e.g., a Queen of hearts being included in a hand or two cards of the same suit being included in a hand); (iii) a hand resulting in a particular payout amount, a minimum payout or a payout within a particular range (e.g., a payout greater than X resulting from a given hand); (iv) a particular sequence of outcomes occurring over a plurality of hands (e.g., three Player side wins in a row, the player losing five wagers in a row, etc.); and (iv) a minimum point value differential between the Player side and the Banker side in a given hand (e.g., at least a 3 point value difference between the Player side and the Banker side in a given hand). In the example of FIGS. 3A-3C, there are three specific qualifying conditions: a Player Pair, a Banker Pair and a Tie. Thus, in some embodiments step 404 may comprise comparing the relevant characteristics and data defining the hand(s) dealt in step 402 to the one or more qualifying conditions defined in the game program (e.g., bonus multiplier program 210b of FIG. 2A).

If it is determined, in step 404, that at least one qualifying condition has been satisfied, the process proceeds to step 406. In step 406 an indicator of the bonus awarding mechanism is modified to indicate that the qualifying condition has been satisfied. For example, a visual appearance of an indicator of the qualifying condition may be lit up, highlighted or otherwise be modified to inform a player that is has now been satisfied (e.g., if it had been unlit, grayed out or otherwise output in a manner indicating that it had not yet been satisfied). In the example of FIGS. 3A-3C, the indicator of each of the three qualifying conditions is a pointer which has the corresponding qualifying condition written thereon. Modifying the indicator of a qualifying condition in FIGS. 3A-3C comprises highlighting the pointer such that its appearance is different from the pointers the qualifying conditions of which have not yet been satisfied. For example, in FIG. 3A, the pointer 302a appears highlighted compared to the pointers 302b and 302c, the qualifying conditions of which have not yet been satisfied.

In some embodiments, step 404 may further include modifying a status of the qualifying condition which has been determined to be satisfied. For example, the status of the condition may be changed from “unsatisfied” to “satisfied” and/or the status of the indicator of the qualifying condition may be changed from “inactive” to “active” (or some functionally similar manner may be used to store, at least in temporary memory which tracks a status of the bonus awarding mechanism for a current session). Such a change in status may be stored in a local memory and/or database of the gaming device on which the baccarat game is being played and/or in a memory and/or database of a game server device. If the satisfaction of the qualifying condition in step 404 is not the first time that particular qualifying condition has been satisfied, there may not be a need to modify an appearance or status of the indicator of the qualifying condition as it would previously have been modified to indicate the satisfaction thereof.

In step 408, a multiplier value of the bonus awarding mechanism is modified or updated to reflect that at least one qualifying condition for activating the bonus awarding mechanism has been satisfied. As described herein, in some embodiments a bonus awarding mechanism includes a multiplier feature. In some embodiments, a multiplier value of the bonus awarding mechanism is set or modified based on an event in the primary game. For example, a multiplier value may be output, modified or updated based on a satisfaction of at least one qualifying condition. In another example, a multiplier value may be determined based on a characteristic of a hand dealt in the primary hand (e.g., a card or outcome included in a hand which satisfies a qualifying condition, such that a hand which satisfies a particular qualifying condition may cause different multiplier values to be set for the bonus awarding mechanism, depending on a characteristic of the hand other than the fact that it satisfies a qualifying condition). In some embodiments, a plurality of multiplier values may be included in a bonus awarding mechanism. For example, in one embodiment which includes a plurality of qualifying conditions for activating the bonus awarding mechanism, each qualifying condition may have a respective multiplier value associated therewith and modifying or updating a multiplier value of the bonus awarding mechanism may comprise modifying or updating the multiplier value corresponding to the satisfied qualifying condition.

In accordance with some embodiments, if the present satisfaction of a qualifying condition is the first time that a qualifying condition has been satisfied, the multiplier value (e.g., the corresponding to this qualifying condition) may be set to an initial or default value. For example, in the embodiment of FIG. 3A, the multiplier value is initially set to 1× when the corresponding qualifying condition is first satisfied. This is illustrated in FIG. 3A via the inclusion of the “1×” multiplier to the pointer 302a. In this example embodiment, the inclusion of the multiplier 1× is indicative that the corresponding qualifying condition of Player Pair has been satisfied once in the current session. Of course another initial multiplier value (e.g., 2×) may be implemented in other embodiments and in some embodiments no multiplier value may be associated with a qualifying condition when it is first satisfied (e.g., a multiplier value is only assigned to a qualifying condition once it is satisfied more than once). In some embodiments, if the satisfaction of the qualifying condition determined in step 404 is not the first time the particular qualifying condition has been satisfied in the given session, the multiplier value corresponding to the qualifying condition may be increased by a predetermined magnitude (e.g., from 1× to 2×, from 2× to 3×, from 2× to 5×, etc.). In some embodiments, the multiplier value may be determined not based on how many times a qualifying condition has been satisfied (or not only based on this factor) but on a characteristic of at least one hand of the primary game (e.g., the multiplier may be set to 2× if the point value for the Player side is greater than Y, the multiplier value may be set to 3× if the hand includes an Ace, etc.). In some embodiments, the value of the multiplier may be determined randomly (e.g., based on an RNG output). In some embodiments, step 408 may comprise determining whether the multiplier value is currently at a maximum multiplier value (in embodiments in which there is a cap or maximum on the value of the multiplier) and only modifying the value of the multiplier if the current value is not the maximum value.

In step 410 it is determined whether each of the required qualifying conditions (if there is more than one) are satisfied in order for the bonus feature to be activated. For example, in the embodiment depicted in FIGS. 3A-3C, it may be determined whether each of a Player Pair, a Banker Pair and a Tie has been obtained in a hand of the primary game during the current session (e.g., since the last time the bonus feature was activated and the qualifying condition statuses reset to default statuses). If each of the qualifying conditions have been satisfied, the bonus feature is activated or made available to the player. In some embodiments, the bonus feature may automatically be initiated once each of the qualifying conditions have been satisfied. In other embodiments, the bonus feature is made available to the player once the qualifying conditions are satisfied such that the player may initiate it at his/her discretion. For example, in the embodiment depicted in FIGS. 3A-3C, once each of the three qualifying conditions have been satisfied the “Spin” button 302f may be activated (e.g., highlighted, made responsive to player input and/or have its status modified to an active status in a memory or database) such that the player may spin the bonus wheel 302d at any point thereafter. In some embodiments, the bonus feature may be activated for some terminate period of time (e.g., for a maximum period of time or until another end condition occurs) such that the player may lose out on an opportunity to play the bonus feature if he/she does not activate it within the appropriate period of time. If it is determined that each of the qualifying conditions has not yet been satisfied, the process 400 returns to step 402, in which step a new hand for the session (e.g., in response to a new wager being placed by the player) is dealt. If, on the other hand, it is determined that each of the qualifying conditions has been satisfied, then process 400 continues to step 412.

In step 412, the bonus awarding mechanism is activated and, in some embodiments, initiated automatically. In other embodiments the bonus awarding mechanism may first be activated but a determination of a bonus prize not initiated until an input is received from a player (e.g., the player actuates a “spin” or other mechanism for initiating a determination of a bonus prize by the bonus awarding mechanism). In the latter embodiments, step 412 may comprise activating the bonus awarding mechanism (e.g., making an input mechanism for initiating the bonus awarding mechanism responsive to player input) and waiting for the player to provide an input initiating the bonus awarding mechanism. In the embodiments illustrated in FIGS. 3A-3C, step 412 may comprise activating the “Spin” button 302f and, after determining that the player has actuated this button, initiating the bonus awarding mechanism. Initiating the bonus awarding mechanism may comprise determining which of the available bonus prizes is to be awarded to the player (e.g., which of the prizes on the wedges of the wheel 302d is to be awarded, in the embodiments of FIGS. 3A-3C). Such a determination may comprise, for example, requesting and receiving an output from an RNG or utilizing a bonus awarding algorithm to determine the prize(s). In some embodiments, more than one prize may be awarded (e.g., in the embodiments of FIGS. 3A-3C, each of the three pointers 302a, 302b and 302c will point to a prize won by the player once the bonus wheel 302d stops spinning). In some embodiments, step 412 may further comprise resetting the status and indicators of the bonus awarding mechanism (e.g., the status and indicators of each qualifying condition and/or an activation status of the bonus awarding mechanism) to indicate that the bonus awarding mechanism is no longer active or available for additional initiation upon the present initiation and bonus prize determination (this resetting may also be done later in the process, such as once the bonus prizes are determined and awarded).

In step 414 the multiplier value(s) determined in step 408 are applied to the prize(s) won based on the outcome of the bonus awarding mechanism. As described herein, in some embodiments multiple multiplier values may be implemented, each corresponding to a respective qualifying condition and corresponding bonus prize. In some embodiments, a game provider may place certain restrictions on an application of the multiplier. For example, in one embodiment a maximum multiplier may be defined for a top or jackpot prize, which restriction in some embodiments may only be implemented if the top or jackpot prize is greater than some predetermined amount. In the embodiments of FIGS. 3A-3C, the multiplier corresponding to each qualifying condition defined by each of the pointers 302a, 302b and 302c at the time the bonus awarding mechanism is initiated is applied to the prize defined on the wedge of the wheel 302d once the wheel stops spinning.

As described herein, in some embodiments a value of a multiplier may be determined based on a characteristic of a hand in a primary game of baccarat. While such an embodiment has been described in the context of a bonus awarding mechanism with respect to process 400 of FIG. 4, applicant recognizes that such an embodiment may have uses outside of a bonus awarding mechanism. For example, a multiplier the value of which is determined based on a characteristic of a hand may be determined and applied in a primary game of baccarat or other types of bonus features for a game of baccarat. FIG. 5 describes a process 500 which generally contemplates determining a value of a multiplier based on a characteristic of a hand of baccarat.

Turning now to FIG. 5, illustrated therein is a process 500 which may be implemented in the context of a primary game of baccarat or a bonus feature for a game of baccarat. In step 502, a new hand is dealt for a game of baccarat. Various methodologies and the attendant consideration for dealing a hand of baccarat have been described herein (e.g., with respect to step 402 of FIG. 4), are applicable to step 502, and will not be repeated for purposes of brevity.

In step 504, a relevant characteristic of the hand is determined (relevant to determining a value for a multiplier to be applied in a hand of baccarat). In some embodiments, this process is performed only for winning hands (e.g., hands which result in a player winning a payout). In some embodiments, the characteristic may comprise a characteristic of a particular side of a hand of baccarat (e.g., a Player side or a Banker side). In some embodiments, the characteristic may comprise a characteristic of a plurality of hands (e.g., a plurality of hands dealt for a single game instance or wager), such as a common characteristic of the hands or a characteristic of some combination of the hands (e.g., a sum of the point values of the hands, whether any of the hands include a certain card, type of card or combination of cards, etc.) of baccarat (e.g., based on a sum value for the hand, based on one or more cards included in a hand, based on whether the hand includes a predetermined combination of cards or a predetermined outcome, etc.).

Examples of relevant characteristics of at least one hand (or a side of at least one hand) which may be used to determine a value of a multiplier include, without limitation: (i) whether a particular card, type of card or combination of cards is included in the at least one hand (e.g., cards of a particular suit, color, rank, or combination of the foregoing); (ii) a particular outcome being included in a hand (e.g., a Player Pair); (ii) a particular card or combination of cards being dealt to a hand (e.g., a Queen of hearts being included in a hand or two or more cards of the same suit, color, or rank being included in a hand); (iii) a hand resulting in a particular payout amount, a minimum payout or a payout within a particular range (e.g., a payout greater than X resulting from a given hand); (iv) a particular sequence of outcomes occurring over a plurality of hands (e.g., three Player side wins in a row, the player losing five wagers in a row, etc.); and (iv) a minimum point value differential between the Player side and the Banker side in a given hand (e.g., at least a 3 point value difference between the Player side and the Banker side in a given hand).

In step 506, a multiplier value is determined based on the relevant characteristic identified in step 504. If more than one relevant characteristic is identified in step 504, a selection process may be implemented for determining which one of the characteristics to use in determining the multiplier value. For example: (i) the characteristic which corresponds (or is most likely to correspond to) the highest multiplier value of possible multiplier values may be selected, (ii) one of the characteristics may be selected at random or (iii) a player may be provided an opportunity to select one of the characteristics. In some embodiments, a game program may store (e.g., in a database or as queries within the game program) a listing or other indication of one or more characteristics which qualify for a multiplier, each characteristic corresponding to a respective multiplier value or range of RNG outputs (such as in a probability table) for use in determining a multiplier value. Such a listing or indication may be accessed in step 506 to select the multiplier value corresponding to the characteristic being used.

In one embodiment, the value of the multiplier may be based on one or more cards in the hand and/or a point value of the hand. In a more particular example, different multiplier values may correspond to different possible values for a given side of a hand. Methodologies for determining a point value of a hand in a game of baccarat were described above (e.g., adding the values of the cards for one of the Banker hand or the Player hand to obtain a resulting value and, for a two digit value, using the right-most number as the value of the Banker hand or the Player hand, respectively). For example, a “natural” winning hand with a point value of “8” or “9” may correspond to a 12× multiplier, a winning hand with a point value of “7” win may correspond to an 8× multiplier, a winning hand of a point value of “6” may correspond to a 2× multiplier and a wining hand with a point value of “4” may correspond to a 3× multiplier. As would be understood, a “natural” win may comprise a win based on the first two cards dealt to a hand (i.e., no third card needed to be dealt in order for the hand to be determined to be a winning hand). The above examples in which multiplier values correspond to final point values (or other characteristics, such as whether a win is a “natural” win) are not intended to be limiting; any arrangement of values or of multiplier values to hand values may be used. It should be noted that not all possible hand values may correspond to a multiplier value. For example, one or more point values obtainable for a hand, even if it is a winning hand, may in some embodiments not correspond to any multiplier value.

In some embodiments, whether a player wins a multiplier as a result of a hand and/or the value of the multiplier may be determined based on the third card dealt to the hand. For example, in one embodiment the third card dealt to a hand (if a third card is dealt) may be either a card with a value which contributes to a point value of the hand or a card which indicates the multiplier value the player wins if the player wins as a result of that hand. In one embodiment, whether the third card is a card which contributes to the point value of the hand or a card which indicates a multiplier value may be a random (or weighted random) determination. In some embodiments, the value of the multiplier won may also be a random (or weighted random) determination.

In accordance with some embodiments, a value of a multiplier may be determined based on an occurrence of a poker hand combination occurring (i) within a given side (i.e. Player side or Banker side) or (ii) within the cards of a given hand from both the Player side and the Banker side. For example, a multiplier value may be determined based on an occurrence of a flush, royal flush, straight, flush, 3 of a kind, 2 pair, pair, etc. In some embodiments, higher ranking hands may correspond to relatively higher multiplier values (e.g., a higher multiplier value would be provided for a flush than would be for a pair).

Once the multiplier value is selected or determined in step 506, it is applied to a payout or prize won by the player in the baccarat game (e.g., a payout won as a result in the primary baccarat game or a prize won as a result of a bonus feature). In one embodiment, the multiplier value is applied to the payout won as a result of the hand which includes the characteristic used to determine the multiplier. In other embodiments, the multiplier value is applied to another payout or prize (e.g., a prize won in a bonus feature, a subsequently dealt hand in a primary game of baccarat).

Various other improvements to an electronic game of baccarat which utilize a multiplier concept are contemplated herein. In accordance with some embodiments, an improvement to known methodologies which could be employed in a game of baccarat comprises providing for a multiplier to be determined as a result of one or more hands of baccarat, the multiplier to be applied to a subsequent hand(s) dealt to the player. In one embodiment, the multiplier may only be provided to or won by the player if the player wins the hand corresponding to the multiplier (i.e., if the player wagered on the Banker hand and the Banker hand does win, the player also wins a multiplier as a result of the hand). In accordance with one embodiment, any multiplier won or otherwise obtained as a result of a hand is applied to a subsequent hand (e.g., the multiplier is applied to a payout the player wins as a result of the subsequent hand, to magnify the payout). In accordance with one embodiment, a player may be required to place an additional or side wager in order to be eligible for the multiplier. In one embodiment, so long as a player places a maximum available wager on a hand or maintains at least a minimum wager (e.g., over a course of a predetermined number of hands or in a current session), the player will be eligible to win a multiplier as a result of that hand.

In embodiments in which multiple hands are dealt, a multiplier won as a result of a particular hand may only be used to multiply the payout won for a subsequent hand (e.g., the very next hand) in the same position as the hand which resulted in the win of the multiplier. For example, if a symbol matrix comprises a plurality of rows and each row comprises a respective hand, assuming a multiplier is won as a result of the hand in the first row (e.g., because the player wagered that the Banker side would win and the Banker side of the hand in the first row does win), then in some embodiments the multiplier won as a result of that hand is only applied to a payout won as a result of the very next hand in the first row.

In accordance with some embodiments, a multiplier which is won as a result of a first hand is only effective for a single subsequent hand. Thus, for example, if a player wins a multiplier of 3× as a result of a first hand and the player wins the subsequent hand, the 3× multiplier is applied to the payout of the subsequent hand and then removed from play (i.e., it is not available for application to any further subsequent hands). Of course, the player may win another multiplier as a result of the subsequent hand, which multiplier may be applied to a third hand. In other embodiments, a multiplier won as a result of a first hand is effective or persistent for more than one subsequent hand.

In one embodiment, an alternate “escalating multiplier” scheme may be utilized to determine a multiplier won as a result of a first hand, which multiplier is to be applied to a payout of a subsequent hand. In such an “escalating multiplier” scheme, the multiplier value may progressively increase as the player keeps winning hands in consecutive game events. Thus, for example, an escalating multiplier scheme such as the following may be implemented in a game:

(i) a player is provided an opportunity to play up to six (6) hands of baccarat (the player may place individual wagers on each of the six hands; in some embodiments the player may be allowed to change the wager amount and/or whether the player is wagering on the Banker hand, Player hand or Tie while in other embodiments the wager must remain the same for all six hands; numbers of hands other than six may be implemented);

(ii) the player will start with one hand (base hand) and, if the player wins their wager (or, some embodiments, gets a tie), the player qualifies to wager on the second hand of the six hands and the second hand will pay a multiplier for any wins;

(iii) if, as a result of the second hand, the player wins their wager (or, in some embodiments, gets a tie), the multiplier corresponding to this second hand is applied to the payout won as a result of the second hand and the player also qualifies, as a result of winning the second hand, to wager on the third hand of the six hands and this third hand will pay a larger multiplier than the previous hand for any wins;

(iv) if, as a result of the third hand, the player wins their wager (or, in some embodiments, gets a tie), the multiplier corresponding to this third hand (which is larger than the multiplier applied in the second hand) is applied to the payout won as a result of the second hand and the player qualifies, as a result of winning the third hand, to place a wager on the fourth hand of the six hands and this fourth hand will pay a larger multiplier than the previous hand for any wins;

(v) if, as a result of the fourth hand, the player wins their wager (or, in some embodiments, gets a tie), the multiplier corresponding to this fourth hand (which is larger than the multiplier applied in the third hand) is applied to the payout won as a result of the fourth hand and the player qualifies, as a result of winning the fourth hand, to place a wager on the fifth hand of the six hands and this fifth hand will pay a larger multiplier than the previous hand for any wins;

(vi) if, as a result of the fifth hand, the player wins their wager (or, in some embodiments, gets a tie), the multiplier corresponding to this fifth hand (which is larger than the multiplier applied in the fourth hand) is applied to the payout won as a result of the fifth hand and the player qualifies, as a result of winning the fifth hand, to place a wager on the sixth and final hand and this sixth hand will pay a larger multiplier than the previous hand for any wins.

In some embodiments, a de-escalating multiplier embodiment may be implemented instead of an escalating one. For example, within a set of a predetermined number of hands, a multiplier which starts of at a relatively high number (e.g., 10×) may gradually be lowered as the player progresses from hand-to-hand.

Numerous embodiments are described in this disclosure, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

### Rules of Interpretation

The present disclosure is neither a literal description of all embodiments nor a listing of features of the invention that must be present in all embodiments.

The Title (set forth at the beginning of the first page of this disclosure) is not to be taken as limiting in any way as the scope of the disclosed invention(s).

The term “product” means any machine, manufacture and/or composition of matter as contemplated by 35 U.S.C. §101, unless expressly specified otherwise.

The terms “an embodiment”, “embodiment”, “embodiments”, “the embodiment”, “the embodiments”, “one or more embodiments”, “some embodiments”, “one embodiment” and the like mean “one or more (but not all) disclosed embodiments”, unless expressly specified otherwise.

The terms “the invention” and “the present invention” and the like mean “one or more embodiments of the present invention.”

A reference to “another embodiment” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The terms “a”, “an” and “the” mean “one or more”, unless expressly specified otherwise.

The term “and/or”, when such term is used to modify a list of things or possibilities (such as an enumerated list of possibilities) means that any combination of one or more of the things or possibilities is intended, such that while in some embodiments any single one of the things or possibilities may be sufficient in other embodiments two or more (or even each of) the things or possibilities in the list may be preferred, unless expressly specified otherwise.

The term “plurality” means “two or more”, unless expressly specified otherwise.

The term “herein” means “in the present disclosure, including anything which may be incorporated by reference”, unless expressly specified otherwise.

The phrase “at least one of”, when such phrase modifies a plurality of things (such as an enumerated list of things) means any combination of one or more of those things, unless expressly specified otherwise. For example, the phrase at least one of a widget, a car and a wheel means either (i) a widget, (ii) a car, (iii) a wheel, (iv) a widget and a car, (v) a widget and a wheel, (vi) a car and a wheel, or (vii) a widget, a car and a wheel.

The phrase “based on” does not mean “based only on”, unless expressly specified otherwise. In other words, the phrase “based on” describes both “based only on” and “based at least on”.

Each process (whether called a method, algorithm or otherwise) inherently includes one or more steps, and therefore all references to a “step” or “steps” of a process have an inherent antecedent basis in the mere recitation of the term ‘process’ or a like term. Accordingly, any reference in a claim to a ‘step’ or ‘steps’ of a process has sufficient antecedent basis.

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When a single device, component or article is described herein, more than one device, component or article (whether or not they cooperate) may alternatively be used in place of the single device, component or article that is described. Accordingly, the functionality that is described as being possessed by a device may alternatively be possessed by more than one device, component or article (whether or not they cooperate).

Similarly, where more than one device, component or article is described herein (whether or not they cooperate), a single device, component or article may alternatively be used in place of the more than one device, component or article that is described. For example, a plurality of computer-based devices may be substituted with a single computer-based device. Accordingly, the various functionality that is described as being possessed by more than one device, component or article may alternatively be possessed by a single device, component or article.

The functionality and/or the features of a single device that is described may be alternatively embodied by one or more other devices that are described but are not explicitly described as having such functionality and/or features. Thus, other embodiments need not include the described device itself, but rather can include the one or more other devices which would, in those other embodiments, have such functionality/features.

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

A description of an embodiment with several components or features does not imply that all or even any of such components and/or features are required. On the contrary, a variety of optional components are described to illustrate the wide variety of possible embodiments of the present invention(s). Unless otherwise specified explicitly, no component and/or feature is essential or required.

Further, although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

Although a process may be described as including a plurality of steps, that does not indicate that all or even any of the steps are essential or required. Various other embodiments within the scope of the described invention(s) include other processes that omit some or all of the described steps. Unless otherwise specified explicitly, no step is essential or required.

Although a product may be described as including a plurality of components, aspects, qualities, characteristics and/or features, that does not indicate that all of the plurality are essential or required. Various other embodiments within the scope of the described invention(s) include other products that omit some or all of the described plurality.

An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise. For example, the enumerated list “a computer, a laptop, a PDA” does not imply that any or all of the three items of that list are mutually exclusive and does not imply that any or all of the three items of that list are comprehensive of any category.

Headings of sections provided in this disclosure are for convenience only, and are not to be taken as limiting the disclosure in any way.

“Determining” something can be performed in a variety of manners and therefore the term “determining” (and like terms) includes calculating, computing, deriving, looking up (e.g., in a table, database or data structure), ascertaining, recognizing, and the like.

A “display” as that term is used herein is an area that conveys information to a viewer. The information may be dynamic, in which case, an LCD, LED, CRT, Digital Light Processing (DLP), rear projection, front projection, or the like may be used to form the display. The aspect ratio of the display may be 4:3, 16:9, or the like. Furthermore, the resolution of the display may be any appropriate resolution such as 480i, 480p, 720p, 1080i, 1080p or the like. The format of information sent to the display may be any appropriate format such as Standard Definition Television (SDTV), Enhanced Definition TV (EDTV), High Definition TV (HDTV), or the like. The information may likewise be static, in which case, painted glass may be used to form the display. Note that static information may be presented on a display capable of displaying dynamic information if desired. Some displays may be interactive and may include touch screen features or associated keypads as is well understood.

The present disclosure may refer to a “control system” or program. A control system or program, as that term is used herein, may be a computer processor coupled with an operating system, device drivers, and appropriate programs (collectively “software”) with instructions to provide the functionality described for the control system. The software is stored in an associated memory device (sometimes referred to as a computer readable medium or an article of manufacture, which may be non-transitory in nature). While it is contemplated that an appropriately programmed general purpose computer or computing device may be used, it is also contemplated that hard-wired circuitry or custom hardware (e.g., an application specific integrated circuit (ASIC)) may be used in place of, or in combination with, software instructions for implementation of the processes of various embodiments. Thus, embodiments are not limited to any specific combination of hardware and software.

A “processor” means any one or more microprocessors, Central Processing Unit (CPU) devices, computing devices, microcontrollers, digital signal processors, or like devices. Exemplary processors are the INTEL PENTIUM or AMD ATHLON processors.

The term “computer-readable medium” refers to any statutory medium that participates in providing data (e.g., instructions) that may be read by a computer, a processor or a like device. Such a medium may take many forms, including but not limited to non-volatile media, volatile media, and specific statutory types of transmission media. Non-volatile media include, for example, optical or magnetic disks and other persistent memory. Volatile media include DRAM, which typically constitutes the main memory. Statutory types of transmission media include coaxial cables, copper wire and fiber optics, including the wires that comprise a system bus coupled to the processor. Common forms of computer-readable media include, for example, a floppy disk, a flexible disk, hard disk, magnetic tape, any other magnetic medium, a CD-ROM, Digital Video Disc (DVD), any other optical medium, punch cards, paper tape, any other physical medium with patterns of holes, a RAM, a PROM, an EPROM, a FLASH-EEPROM, a USB memory stick, a dongle, any other memory chip or cartridge, a carrier wave, or any other medium from which a computer can read. The terms “computer-readable memory”, “article of manufacture” and/or “tangible media” specifically exclude signals, waves, and wave forms or other intangible or non-transitory media that may nevertheless be readable by a computer.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols. For a more exhaustive list of protocols, the term “network” is defined below and includes many exemplary protocols that are also applicable here.

It will be readily apparent that the various methods and algorithms described herein may be implemented by a control system and/or the instructions of the software may be designed to carry out the processes of the present invention.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models, hierarchical electronic file structures, and/or distributed databases) could be used to store and manipulate the data types described herein. Likewise, object methods or behaviors of a database can be used to implement various processes, such as those described herein. In addition, the databases may, in a known manner, be stored locally or remotely from a device that accesses data in such a database. Furthermore, while unified databases may be contemplated, it is also possible that the databases may be distributed and/or duplicated amongst a variety of devices.

As used herein a “network” is an environment wherein one or more computing devices may communicate with one another. Such devices may communicate directly or indirectly, via a wired or wireless medium such as the Internet, LAN, WAN or Ethernet (or IEEE 802.3), Token Ring, or via any appropriate communications means or combination of communications means. Exemplary protocols include but are not limited to: Radio Frequency Identification (RFID), Bluetooth™, Time Division Multiple Access (TDMA), Code Division Multiple Access (CDMA), Global System for Mobile communications (GSM), Enhanced Data rates for GSM Evolution (EDGE), General Packet Radio Service (GPRS), Wideband CDMA (WCDMA), Advanced Mobile Phone System (AMPS), Digital AMPS (D-AMPS), IEEE 802.11 (WI-FI), IEEE 802.3, SAP, the best of breed (BOB), system to system (S2S), or the like. Note that if video signals or large files are being sent over the network, a broadband network may be used to alleviate delays associated with the transfer of such large files, however, such is not strictly required. Each of the devices is adapted to communicate on such a communication means. Any number and type of machines may be in communication via the network. Where the network is the Internet, communications over the Internet may be through a web site maintained by a computer on a remote server or over an online data network including commercial online service providers, bulletin board systems, and the like. In yet other embodiments, the devices may communicate with one another over RF, cable TV, satellite links, and the like. Where appropriate encryption or other security measures such as logins and passwords may be provided to protect proprietary or confidential information.

Communication among computers and devices may be encrypted to insure privacy and prevent fraud in any of a variety of ways well known in the art. Appropriate cryptographic protocols for bolstering system security are described in Schneier, APPLIED CRYPTOGRAPHY, PROTOCOLS, ALGORITHMS, AND SOURCE CODE IN C, John Wiley & Sons, Inc. 2d ed., 1996, which is incorporated by reference in its entirety.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

It will be readily apparent that the various methods and algorithms described herein may be implemented by, e.g., appropriately programmed general purpose computers and computing devices. Typically a processor (e.g., one or more microprocessors) will receive instructions from a memory or like device, and execute those instructions, thereby performing one or more processes defined by those instructions. Further, programs that implement such methods and algorithms may be stored and transmitted using a variety of media (e.g., computer readable media) in a number of manners. In some embodiments, hard-wired circuitry or custom hardware may be used in place of, or in combination with, software instructions for implementation of the processes of various embodiments. Thus, embodiments are not limited to any specific combination of hardware and software. Accordingly, a description of a process likewise describes at least one apparatus for performing the process, and likewise describes at least one computer-readable medium and/or memory for performing the process. The apparatus that performs the process can include components and devices (e.g., a processor, input and output devices) appropriate to perform the process. A computer-readable medium can store program elements appropriate to perform the method.

What is claimed is:

1. An apparatus for facilitating an electronic baccarat game, the apparatus comprising:
a processor,
a display device operable to output (i) a first electronic game interface for displaying outcomes of a primary game of baccarat and (ii) a second electronic game interface for displaying a bonus payout feature,
an input device, and
a game controller comprising:
a processor, and
a first non-transitory memory operable to communicate with the processor, the first memory storing a game program comprising instructions for directing the processor to manage the electronic baccarat game, wherein the processor is operable with the game program to:
output, on the display device, the first electronic game interface comprising an area for displaying at least one hand of baccarat, each at least one hand of baccarat comprising a plurality of element positions for placement of game elements and including a first subset of the plurality of element positions corresponding to a Player side and a second subset of the plurality of element positions corresponding to a Banker side;
output, on the display device, the second electronic game interface comprising a bonus awarding mechanism having displayed thereon a plurality of available bonus prizes and an indicator of a plurality of activation conditions which must be obtained during play of the primary game in order for the bonus awarding mechanism to be activated;
determine, for each plurality of element positions comprising a hand, an outcome of the hand;
place, for a game instance of the primary game on which a player has placed a wager and based on the determined outcomes, game elements into the plurality of element positions for each hand;
determine which one of Player side and Banker side the player has selected when placing the wager, thereby determining the player's win prediction for the game instance;
determine a primary payout for the game instance of the primary game based on an amount of the wager, the player's win prediction and the outcome for each hand;
determine that at least one outcome satisfies at least one activation condition for the bonus feature;
modify the second electronic game interface to indicate that at least one activation condition has been satisfied;
determine that each of the plurality of activation conditions for the bonus awarding mechanism has been satisfied over a course of at least one game instance of the primary game, thereby activating the bonus awarding mechanism;
award a bonus prize based on a resolution of the bonus awarding mechanism.

2. The system of claim 1, wherein the bonus awarding mechanism comprises a bonus wheel with available prizes displayed in wedge-shaped areas of the bonus wheel.

3. The system of claim 2, wherein the bonus wheel includes a plurality of pointers along its circumference, each pointer including a display area and corresponding to a predetermined outcome of the primary game which must be obtained during play of the primary game in order for the bonus awarding mechanism to be activated.

4. The system of claim 3, wherein each pointer further includes an area for indicating a multiplier to be applied to a bonus prize on which the pointer lands.

5. The system of claim 4, wherein a value of the multiplier is determined based on a characteristic of a hand in the primary game of baccarat.

6. The system of claim 5, wherein the characteristic comprises at least one of: a value of at least one card in the hand, an identity of at least one card in the hand, a point value of the hand and an outcome of the hand.

7. The system of claim 4, wherein the processor is further operable with the game program to increment the multiplier corresponding to a given pointer each time the predetermined outcome of the primary game that corresponds to the pointer is obtained during play of the primary game.

8. The system of claim 7, wherein the processor is further operable with the game program to reset the multiplier corresponding to each pointer to an initial value after each activation and resolution of the bonus wheel.

9. The system of claim 7, wherein the processor is further operable with the game program to reset the multiplier corresponding to each pointer to an initial value once an outcome of the bonus wheel matches a predetermined outcome.

10. The system of claim 1, wherein the processor is further operable with the program to increase a multiplier value associated with the bonus awarding mechanism each time at least one activation condition is satisfied.

11. The system of claim 1, wherein the at least one activation condition comprises a predetermined outcome for a hand of the primary game.

12. The system of claim 11, wherein the at least one predetermined outcome comprises at least one of a Player Pair, a Banker Pair and a Tie.

13. An apparatus for facilitating an electronic baccarat game, the apparatus comprising:
a processor,
a display device;
an input device, and
a game controller comprising:
a processor, and
a first non-transitory memory operable to communicate with the processor, the first memory storing a game program comprising instructions for directing the processor to manage the electronic baccarat game, wherein the processor is operable with the game program to:
output, on the display device, an electronic game interface comprising (i) an area for displaying at least one hand of baccarat, the area comprising, for each at least one hand, a plurality of element positions for placement of game elements and including a first subset of the plurality of element positions corresponding to a Player side and a second subset of the plurality of element positions corresponding to a Banker side; and (ii) an indicator of at least one multiplier to be applied to a prize awarded in the electronic baccarat game;
determining an outcome of the first hand, including the game elements to place for a first hand;
place, for a game instance of the primary game on which a player has placed a wager, a first set of game elements into a first plurality of element positions to represent the outcome of the first hand for the game instance;
determine which one of Player side and Banker side the player has selected when placing the wager, thereby determining the player's win prediction for the game instance;
determine a value of the multiplier based on a characteristic of the first hand;
modify the electronic game interface to indicate the determined value;
determine a payout for the game instance of the primary game based at least on the player's win prediction, the outcome and the value of the multiplier.

14. The system of claim 13, wherein the display device comprises a display device operable to output (i) a first electronic game interface for displaying outcomes of a primary game of baccarat and (ii) a second electronic game interface for displaying a bonus payout feature within which the multiplier is applied.

15. The system of claim 14, wherein the processor being operable with the game program to output on the display device comprises the processor being operable with the program to:
output, on the display device, a first electronic game interface comprising an area for displaying at least one hand of a primary game of baccarat; and
output, on the display device, a second electronic game interface comprising a bonus awarding mechanism having displayed thereon a plurality of available bonus prizes,
wherein the an indicator of at least one multiplier to be applied to a prize awarded within the game is output in at least one of the first electronic game interface and the second electronic game interface.

16. The system of claim 15, wherein the processor is further operable with the game program to:
activate the bonus awarding mechanism once an activation condition is satisfied; and
award a bonus payout amount based on a resolution of the bonus awarding mechanism and the value of the multiplier.

17. The system of claim 13, wherein the characteristic comprises at least one of: a value of at least one card in the first hand, an identity of at least one card in the first hand, a point value of the first hand and the outcome of the first hand.

18. An apparatus for facilitating an electronic baccarat game, the apparatus comprising:
a processor,
a display device;
an input device, and
a game controller comprising:
a processor, and
a first non-transitory memory operable to communicate with the processor, the first memory storing a game program comprising instructions for directing the processor to manage the electronic baccarat game, wherein the processor is operable with the game program to:
output, on the display device, an electronic game interface comprising (i) an area for displaying at least one hand of baccarat, each at least one hand of baccarat comprising a plurality of element positions for placement of game elements and including a first subset of the plurality of element positions corresponding to a Player side and a second subset of the plurality of element positions corresponding to a Banker side; and (ii) an indicator of at least one multiplier to be applied to a prize awarded in the electronic baccarat game;
place, for a first game instance of the primary game on which a player has placed a first wager, a first set of game elements into a first plurality of element positions, thereby determining a first hand for the first game instance;
determine which one of Player side and Banker side the player has selected when placing the first wager, thereby determining the player's first win prediction for the first game instance;
determine a first outcome of the first hand;
determine a value of the multiplier based on a characteristic of the first hand, thereby determining a first multiplier value;
modify the electronic game interface to indicate the first multiplier value;
determine a first payout for the first game instance based at least on the player's first win prediction and the first outcome of the first hand;
place, for a second game instance of the primary game on which a player has placed a second wager subsequent to the determining of the first outcome, a second set of game elements into the first plurality of element positions, thereby determining a second hand for the second game instance;
determine which one of Player side and Banker side the player has selected when placing the second wager, thereby determining the player's second win prediction for the second game instance;
determine a second outcome of the second hand;
determine a second payout for the second hand based on the second win prediction, the second outcome and the first multiplier value determined based on the characteristic of the first hand.

19. The system of claim 18, wherein the processor is further operable with the game program to:
determine a second multiplier value based on a characteristic of the second hand;
modify the electronic game interface to indicate the second multiplier value;
place, for a third game instance of the primary game on which a player has placed a third wager subsequent to the determining of the second outcome, a third set of game elements into the first plurality of element positions, thereby determining a third hand for the third game instance;
determine which one of Player side and Banker side the player has selected when placing the third wager, thereby determining the player's third win prediction for the third game instance;
determine a third outcome of the third hand;
determine a third payout for the third hand based on the third win prediction, the third outcome and the second multiplier value determined based on the characteristic of the second hand.

20. The system of claim 19, wherein the second multiplier value is greater than the first multiplier value.
